(19) United States
(12) Patent Application Publication
(10) Pub. No.: US 2026/0340743 A1
(43) Pub. Date: Oct. 29, 2026

(54) INFORMATION PROCESSING METHOD, INFORMATION PROCESSING DEVICE, AND PROGRAM

(71) Applicant: Hideaki Kikuchi, Taipei City (TW)

(72) Inventor: Hideaki Kikuchi, Taipei City (TW)

(21) Appl. No.: 19/111,523

(22) PCT Filed: Sep. 8, 2023
(86) PCT No.: PCT/JP2023/032883

§ 371 Date: Mar. 13, 2025

(30) Foreign Application Priority Data
Sep. 13, 2022 (JP) 2022-145480

(51) Int. Cl. G06Q 50/16; H04N 23/60; H04N 23/61

(52) U.S. Cl. CPC G06Q 50/16; H04N 23/61; H04N 23/64

(57) ABSTRACT

Provided is an information processing method, for example, that can enhance the quality of the contents of introduction of real-estate properties using video content, to thereby increase the level of customer satisfaction felt by users including a contract seeker and an owner. A computer outputs property information and video content concerning a plurality of real-estate properties. Then, if a contract is reached regarding a real-estate property of which the property information and video content have been output, the computer allocates an incentive to the creator of the video content for the real-estate property.

### TECHNICAL FIELD

The present disclosure relates to an information processing method, an information processing device, and a program.

### PRIOR ARTS

Conventionally, information on real estate properties has been disclosed via networks such as the internet, and a process of searching for properties that meet the desired conditions of a prospective contract holder has been carried out via the network. Property searches are conducted based on criteria such as the location of the property, price, size, layout, age, facilities and equipment, and distance from the station. For example, Patent Document 1 discloses a system that provides search results that take into account the content of special properties in addition to the property criteria described above.

### PRIOR DOCUMENT

### Patent Document

Patent Document 1: JP 2020-194222A

### SUMMARY OF THE INVENTION

### Technical Problem

In addition to the information concerning the searched property, photos of the interior of the property are often presented as the results of the real estate property. Some contract seekers may conclude a contract based solely on the information in the search results, without actually going to the site to see the property, and for such contract seekers, the impression from the photos of the property may be the deciding factor in deciding to conclude the contract. Further, contract seekers may use the search results to narrow down the properties to be desired to view before visiting the site, and in such cases, the photos presented as search results are important. However, property photos are often shot by sales representatives or the like, and there is a problem that it is difficult to post attractive photos that will catch the eye of contract seekers and lead to a contract or a viewing. There is a case that even if looking at photos of the property and going to the property to view, the seekers may not like the site, and also a case that the seekers who are short on time, such as those who live in another country or far away, the seekers may be forced to sign a contract to save time even though the seekers are not completely satisfied, and then end up canceling the contract and moving out. In other words, customer satisfaction in real estate (rental and transfer) transactions was insufficient for both property contract seekers and owners.

Therefore, the main objective of the present disclosure is to provide an information processing method, and the like that can enhance the quality of the contents of introduction of real estate properties by using video content, to thereby increase the level of customer satisfaction felt by users including a contract seeker and an owner.

### Solution to Problem

In an information processing method according to one aspect of the present disclosure, a computer executes a process in which outputting property information and video content relating to a plurality of real estate properties, and when a contract for the real estate property is concluded, an incentive is granted to the creator of the video content.

### Effects of the Invention

According to the present invention by the present disclosure, it is possible to improve the quality of the introduction contents and matching of the real estate properties by the video contents to enhance customer satisfaction of the users including contract seekers and owners, and also to make effective use of creators who provide video contents. Therefore, according to the present invention at least both the real estate industry and the creator industry can be revitalized. Further, according to the present invention, for example, a contract seeker who wishes to enter into a real estate (rental or transfer) transaction can transact directly with the property owner or management company (that is, can omit the transaction through a real estate agent), and furthermore, can also omit actual visit of the real estate property to inspect (visit the property). From these viewpoints, the present invention can be said to be a groundbreaking invention that rewrites and reconstructs the conventional structure of real estate transactions, thereby realizing price destruction and redrawing the industry map in the real estate industry.

### BRIEF EXPLANATION OF THE DRAWINGS

FIG. 1 is a schematic diagram showing an example of the configuration of an information processing system.

FIG. 2 is a block diagram showing an example of the configuration of a server and a user terminal.

FIG. 3 is an explanatory diagram showing an example of a record layout of a property information DB.

FIG. 4A is an explanatory diagram showing an example of a record layout of a status DB.

FIG. 4B is an explanatory diagram showing an example of a record layout of a creator DB.

FIG. 5 is a flowchart showing an example of a property search processing procedure.

FIG. 6 is a flowchart showing an example of a property search processing procedure.

FIG. 7A is a schematic diagram showing an example of a screen of a user terminal.

FIG. 7B is a schematic diagram showing an example of a screen of a user terminal.

FIG. 8 is a schematic diagram showing an example of a screen of a user terminal.

FIG. 9 is a flowchart showing an example of a creator evaluation processing procedure.

FIG. 10 is a flowchart showing an example of a property search processing procedure according to the embodiment 2.

FIG. 11 is a schematic diagram showing an example of a screen of a user terminal.

FIG. 12 is a block diagram showing an example of the configuration of a shooting terminal.

FIG. 13 is an explanatory diagram showing an example of a record layout of a status DB according to the embodiment 3.

FIG. 14 is a flowchart showing an example of a shooting processing procedure.

FIG. 15A is an explanatory diagram showing an example of a screen.

FIG. 15B is an explanatory diagram showing an example of a screen.

FIG. 15C is an explanatory diagram showing an example of a screen.

FIG. 15D is an explanatory diagram showing an example of a screen.

FIG. 16 is a flowchart showing an example of a registration processing procedure of a property information.

FIG. 17 is a flowchart showing an example of a property search processing procedure according to the embodiment 3.

FIG. 18A is a schematic diagram showing an example of a screen of a user terminal.

FIG. 18B is a schematic diagram showing an example of a screen of a user terminal.

FIG. 19 is a flowchart showing another example of a property search processing procedure.

FIG. 20 is a flowchart showing an example of a property search processing procedure according to the embodiment 4.

FIG. 21A is a schematic diagram showing an example of a screen of a user terminal.

FIG. 21B is a schematic diagram showing an example of a screen of a user terminal.

FIG. 21C is a schematic diagram showing an example of a screen of a user terminal.

### EMBODIMENTS FOR ACHIEVING THE INVENTION

Hereinafter, an information processing method, an information processing device, and a program according to the present disclosure will be described in detail with reference to the drawings showing embodiments thereof. In the following embodiment, an example will be described in which the present invention is applied to an information processing system that searches for real estate properties via a network and provides information on the searched properties. However, the technology disclosed herein can be applied to information processing systems that search for various objects, not only the real estate properties, via a network and present photos and images of the searched objects as search results.

### Embodiment 1

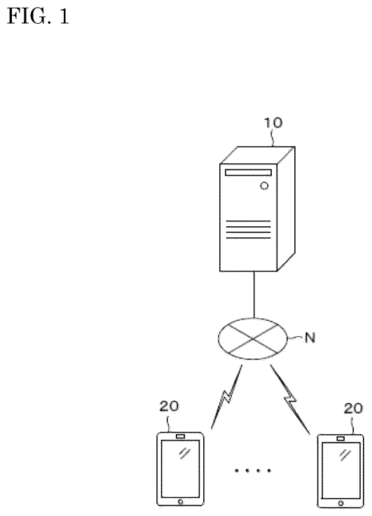

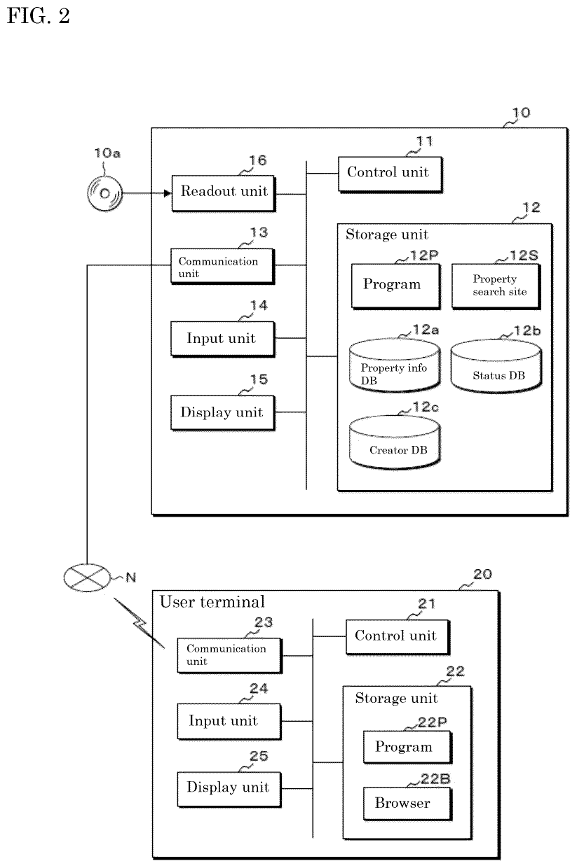

Explaining an information processing system that provides search results for real estate properties via a network. In this embodiment, the real estate properties include properties for sale and properties for rent. FIG. 1 is a schematic diagram showing an example of the configuration of an information processing system. The information processing system of this embodiment includes a server 10 and a plurality of user terminals 20, and each device is communicatively connected via a network N. The network N may be the internet, and may be a LAN (Local Area Network) constructed within a facility where the operator of this information processing system manages the server 10 (may be an individual or a corporation, and may be a real estate company, but is not limited to a real estate company). The server 10 is an information processing device capable of various information processes and transmitting and receiving information, and is a server computer, a personal computer, or the like. The server 10 may be a multi-computer consisting of a plurality of computers, or may be a virtual machine virtually constructed within a single device by software. Further, the server 10 may be a local server installed within a facility, or a cloud server connected for communication via the internet. The server 10 has a function of a web server, and makes available via the network N a property search site 12S (see FIG. 2) that provides information on the real estate properties. The server 10 performs the process of searching for real estate properties, process of providing information on the searched properties, and the like, based on the information for search received from the user terminal 20 via the property search site 12S. The user terminal 20 is a terminal of a user who uses a website, and is a smartphone, a tablet terminal, a personal computer, or the like. The user terminal 20 performs processes such as accessing websites via the network N.

FIG. 2 is a block diagram showing an example of the configuration of the server 10 and the user terminal 20. The server 10 includes a control unit 11, a storage unit 12, a communication unit 13, an input unit 14, a display unit 15, a reader unit 16, and the like, and these units are interconnected via a bus. The control unit 11 includes one or more processors such as a CPU (Central Processing Unit), an MPU (Micro-Processing Unit), or a GPU (Graphics Processing Unit). The control unit 11 appropriately executes a program 12P stored in the storage unit 12 to perform various information processing, control processing, and the like that should be performed by the server 10.

The storage unit 12 includes a RAM (Random Access Memory), a flash memory, a hard disk, an SSD (Solid State Drive), and the like. The storage unit 12 previously stores the program 12P (program product) to be executed by the control unit 11 and various data required for executing the program 12P. Further the storage unit 12 temporarily stores data and the like that are generated when the control unit 11 executes the program 12P. Further, the storage unit 12 stores a property search site 12S for providing information on the real estate properties, a property information DB 12a, a status DB 12b, a creator DB 12c, and the like, which will be described later. At least one of the property information DB 12a, the status DB 12b, and the creator DB 12c may be stored in another storage device connected to the server 10, or in another storage device with which the server 10 can communicate.

The communication unit 13 is a communication module for connecting to the network N by wired communication or wireless communication, and transmits and receives information to and from other devices via the network N. The input unit 14 receives an operation input by the user, and sends a control signal corresponding to the operation content to the control unit 11. The display unit 15 is a liquid crystal display, an organic EL display, or the like, and displays various information according to instructions from the control unit 11. The input unit 14 and the display unit 15 may be an integrated touch panel. Note that, the input unit 14 and the display unit 15 are not essential, and the server 10 may be configured to receive operations through a connected terminal device and output information to be displayed to an external display device.

The reader unit 16 reads the information stored in a portable storage medium 10a including a CD (Compact Disc)-ROM, a DVD (Digital Versatile Disc)-ROM, a USB (Universal Serial Bus) memory, an SD (Secure Digital) card, and the like. The program 12P and various data stored in the storage unit 12 may be read by the control unit 11 from the portable storage medium 10a via the reader unit 16 and stored in the storage unit 12. Further, the program 12P and various data stored in the storage unit 12 may be downloaded by the control unit 11 from another device via the communication unit 13 and stored in the storage unit 12.

In the server 10 configured as described above, the program 12P may be located and executed on a single computer, or at one site, or can be deployed to execute on multiple computers distributed across multiple sites and interconnected by the network N.

The user terminal 20 includes a control unit 21, a storage unit 22, a communication unit 23, an input unit 24, a display unit 25, and the like, and these units are interconnected via a bus. The control unit 21, the storage unit 22, the communication unit 23, the input unit 24, and the display unit 25 of the user terminal 20 have the same configuration as the control unit 11, the storage unit 12, the communication unit 13, the input unit 14, and the display unit 15 of the server 10, so their explanation is omitted. Note that, other than the program 22P, the storage unit 22 of the user terminal 20 stores a browser 22B for browsing websites published via the network N.

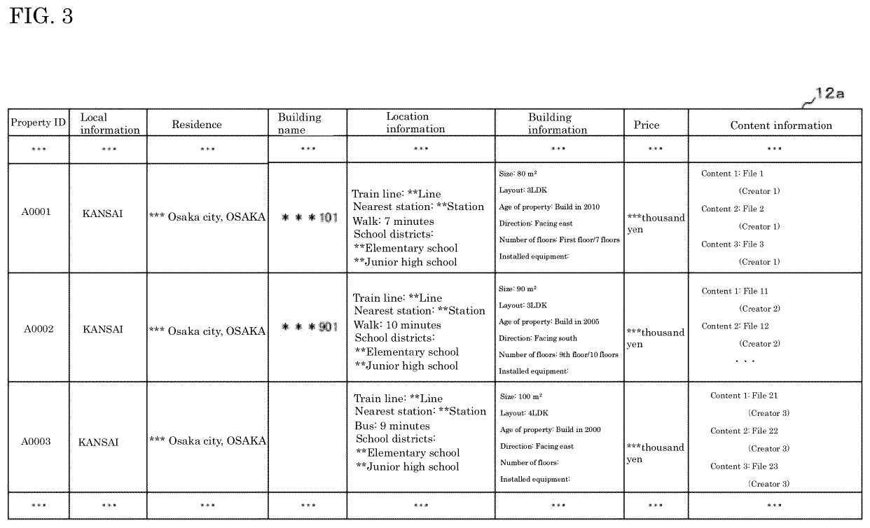

FIG. 3 is an explanatory diagram showing an example of a record layout of the property information DB 12a. The property information DB 12a is a database that stores information on the real estate properties that are registered in the server 10 and can be searched for on the property search site 12S. The property information DB 12a shown in FIG. 3 includes a property ID column, a local information column, a residence column, a building name column, a location information column, a building information column, a price column, a content information column, and the like, and stores the property information related to the properties in correspondence with the property ID. The property ID column stores an identification information (property ID) assigned to each real estate property being searchable on the property search site 12S. The local information column, the residence column, and the building name column store the local area (Kansai, Kanto, Tokai, county, state, etc.) where the real estate property is located, the address of the residence, and the building name, respectively. The location information column, building information column, and price column store information relating to the location of the real estate property, information relating to the building, and price (rent, selling price, etc.), respectively. The location information includes, for example, the name of the line and station name of the nearest station to the real estate property, the means of transportation and travel time from the nearest station, the school districts (school districts) of elementary and junior high schools, and information on the nearest parks and commercial facilities. The building information includes, for example, the size of the real estate property, the layout, the age of the property, the orientation of the veranda or balcony, the number of floors of the building and the number of floors of the property, and information on installed equipment. The content information column stores the video content of the real estate property. The video content includes moving images and still images that are shot (produced) by the creators and introduce the real estate properties, and includes, for example, the content that captures roads, parks, commercial facilities surrounding the real estate property, and the content that captures the interior of the property. Further, the video content includes a main video content that, for example, starts from the entrance of the property, moves around each room in the property, and introduces each part of the property in order. Further, the video content includes the content data (video data) and information about the creator who produced the content. The creator information includes the full name and nick name of the creator, and the name of the organization to which the creator belongs, and the like. Note that, the creator may be a professional or amateur individual shooter (cameraman), or may be the owner of the property. Further, the creator may be a corporation or group of multiple people who create content, including a shooter, art director, illustrator, copywriter, and the like. In addition to being stored in the property information DB 12a, the video content data may be stored in a specified area of the storage unit 12 or in other storage devices, in this case, the content information column stores information for reading out the content data (for example, a file name indicating the storage location of the data). The contents stored in the property information DB 12a are not limited to the example shown in FIG. 3. For example, information on the real estate company and a person in charge who handles inquiries and contracts regarding the real estate properties may be stored.

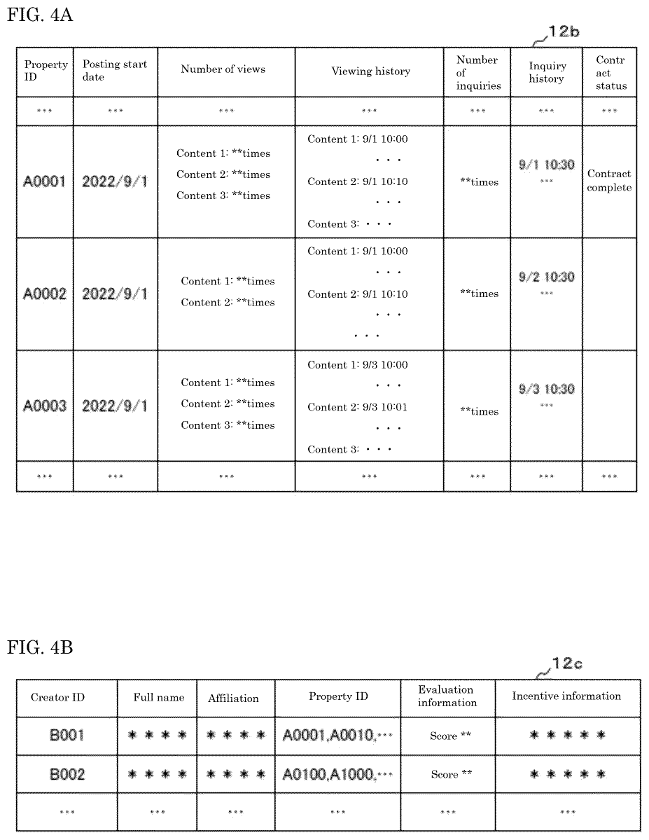

FIG. 4A is an explanatory diagram showing an example of a record layout of the status DB 12b, and FIG. 4B is an explanatory diagram showing an example of a record layout of the creator DB 12c. The status DB 12b is a database that stores information regarding the viewing status of video content, the status of inquiries, the status of contracts, and the like, for the real estate properties that can be searched for on the property search site 12S. The status DB 12b shown in FIG. 4A includes a property ID column, a posting start date column, a number of views column, a viewing history column, a number of inquiries column, an inquiry history column, a contract status column, and the like, and stores the access status of contract seekers to contract with the property in correspondence with the property ID. The property ID column stores the property ID registered in the property information DB 12a. The posting start date column stores the date on which property information was posted on the property search site 12S and became searchable. The number of views column stores the number of times each video content of the property has been viewed, and the viewing history column stores the date and time when each video content has been viewed. The number of inquiries column stores the number of inquiries received regarding the property and the contract, and the inquiry history column stores the date and time when the inquiry was received. Inquiries regarding the properties and contracts are made, for example, via an inquiry form on the property search site 12S, but may also include inquiries made by telephone or email by the users who have viewed the property search site 12S. The contract status column stores information indicating whether or not a contract for the property has been concluded (whether or not a sale or contract has been concluded). In the example shown in FIG. 4A, when a contract is concluded, “contract completed” is stored. The contents stored in the status DB 12b are not limited to the example shown in FIG. 4A. For example, if the user browsing the property search site 12S has registered as a member in advance, information about users who viewed the video content of each property, information about users who made inquiries, information about users who entered into contracts, and the like may be stored.

The creator DB 12c is a database that stores information about creators who have shot (produced) the video content posted on the property search site 12S. The creator DB 12c shown in FIG. 4B includes a creator ID column, a full name column, an affiliation column, a property ID column, an evaluation information column, an incentive information column, and the like, and stores each information about a creator in correspondence with the creator ID. The creator ID column stores the identification information (creator ID) assigned to each creator. The full name column stores the full name or nick name of the creator, and the affiliation column stores information such as the name of the organization to which the creator belongs. The property ID column stores the property ID of the property for which the creator shot (produced) the video content. The evaluation information column stores an evaluation score indicating an evaluation of the creator. The evaluation score is calculated on the property search site 12S based on the viewing status of the video content shot by the creator, the inquiry status and the contract status of the property for which the creator shot the video content. It may also include information regarding whether the creator owns a specified equipment, working examples of video content shot by the creator, and information regarding the rate of the creator. The incentive information column stores information regarding incentives given to the creator depending on the viewing status of the video content shot by the creator, the inquiry status of the property for which the creator shot the video content, and the contract status. The incentive may be money or a coupon, or may be a reward such as points that can be used to pay various fees or points that can be exchanged for various goods. The amount of the incentive is preset according to the number of times or the duration of viewing of the video content, the number of inquiries about the property, or whether or not a contract has been concluded. For example, the more times the video content is viewed, the longer the viewing time, and the more inquiries about the property, the higher the incentive is set, and a predetermined amount of incentive is also set for the conclusion of a contract for the property. The contents stored in the creator DB 12c are not limited to the example shown in FIG. 4B. For example, information such as the contract status of the property where the creator shot the video content, the viewing status of the video content, and the status of inquiries about the property may be stored.

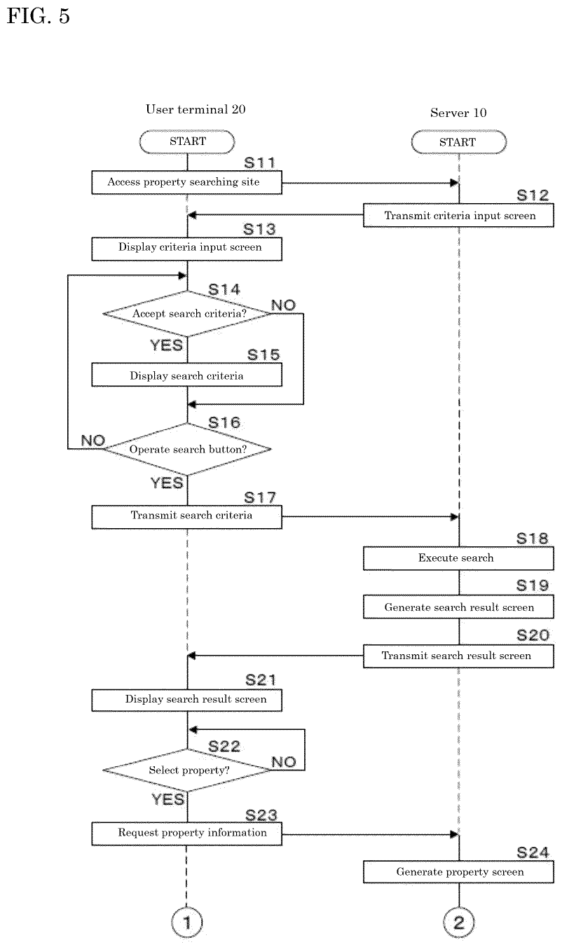

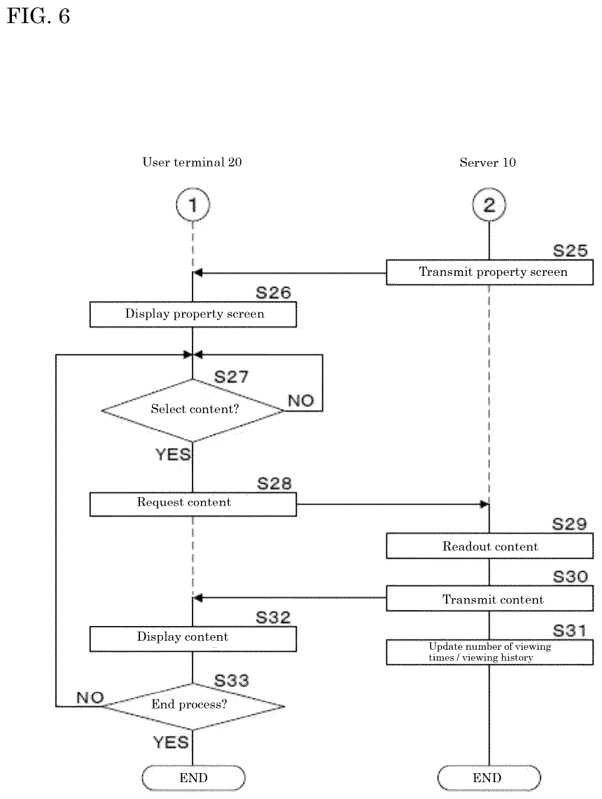

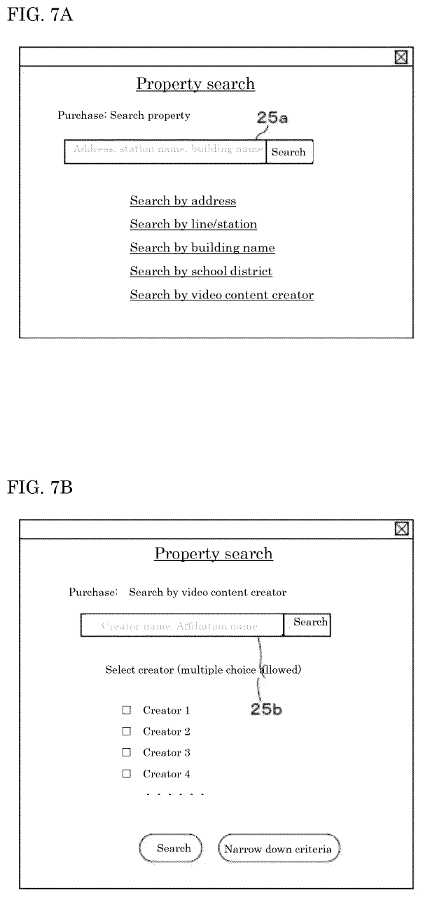

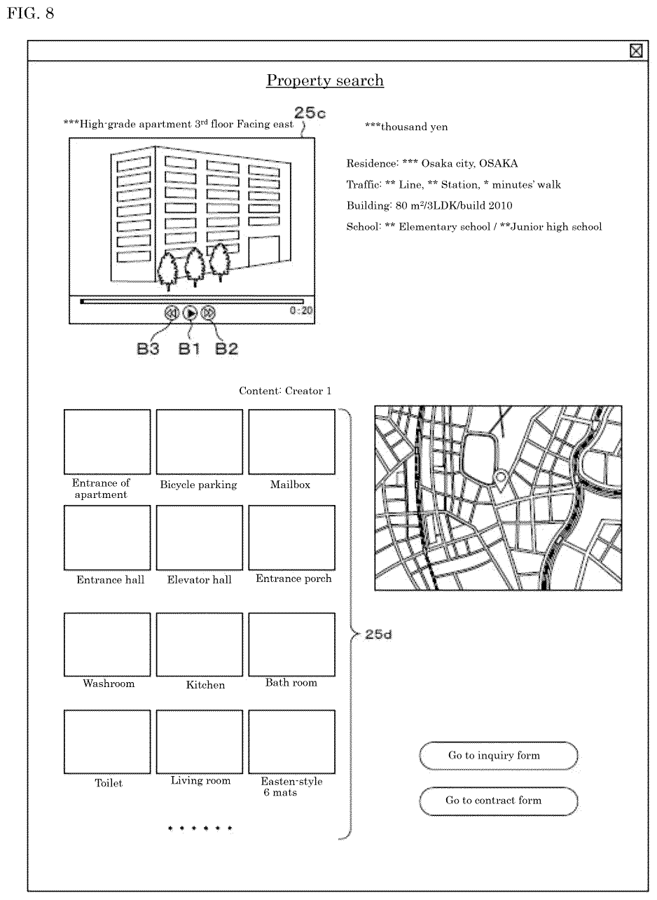

In the following, in the information processing system of this embodiment, explanation of the processing performed by each device when a user accesses the property search site 12S by using the user terminal 20 to search for property information will be performed. FIG. 5 and FIG. 6 are flow charts showing an example of a property search process procedure, and FIG. 7A to FIG. 8 are schematic diagrams showing an example of a screen of a user terminal 20. The following processing is performed by the control unit 21 of the user terminal 20 in accordance with a program 22P stored in the storage unit 22, and by the control unit 11 of the server 10 in accordance with a program 12P stored in the storage unit 12.

In the information processing system of this embodiment, a user who wishes to search for a property accesses the server 10 by using the user terminal 20 and searches for the property which the user wishes to view via the property search site 12S. Note that, the user accesses the server 10 by launching the browser 22B on the user terminal 20, but if an application program for accessing the property search site 12S is installed on the user terminal 20, the user may also access the server 10 by launching this application program on the user terminal 20.

When receiving an instruction to access the server 10 (property search site 12S) via the input unit 24, the control unit 21 of the user terminal 20 accesses the property search site 12S (S11). The control unit 11 of the server 10 transmits a web page in response to the request from the user terminal 20, in this case a criteria input screen of the property search site 12S, to the user terminal 20 (S12). The control unit 21 of the user terminal 20 receives the web page transmitted by the server 10, and displays a criteria input screen, for example as shown in FIG. 7A, on the display unit 25 based on the received web page (S13). The screen shown in FIG. 7A is the initial screen of the criteria input screen, and is a screen for accepting the selection of a category when searching for a property. In the example shown in FIG. 7A, address, railroad line name and station name, building name, school district, and creator of the video content can be selected as categories. Note that, the screen shown in FIG. 7A has an input field 25a for inputting any search keyword for searching for properties, and is configured to enable property searches based on search keywords such as part of an address, a station name, a building name, a school name, and the like.

When any category is selected on the screen shown in FIG. 7A, the screen for accepting input of search criteria related to the selected category is displayed on the user terminal 20, and the control unit 21 accepts the input of search criteria via this screen. For example, when the “Search by address” button is selected on the screen shown in FIG. 7A, the control unit 21 of the user terminal 20 obtains a criteria input screen (not shown) for inputting search criteria related to the address from the server 10, displays it on the display unit 25, and accepts the input of search criteria related to the address via this screen. Similarly, when the “Search by line/station” button is selected, the control unit 21 retrieves from the server 10 a criteria input screen (not shown) for inputting search criteria related to the lines and stations, and displays it, and accepts input of search criteria related to lines and stations via this screen. Further, when the “Search by building name” button is selected, the control unit 21 retrieves from the server 10 a criteria input screen (not shown) for inputting search criteria related to the building names, and displays it, and accepts input of search criteria related to the building name via this screen. Also, when the “Search by school district” button is selected, the control unit 21 retrieves from the server 10 a criteria input screen (not shown) for inputting search criteria related to the school district, and displays it, and accepts input of search criteria related to the school district via this screen.

When the “Search by video content creator” button is selected, the control unit 21 retrieves from the server 10 and displays a criteria input screen for inputting search criteria related to the creator, such as that shown in FIG. 7B. The screen shown in FIG. 7B has check boxes for selecting any creator from among the creators registered in the server 10, and the selection of any creator can be accepted via the check boxes. This makes it possible to execute the property search for each creator, and provide search results for each creator. Further, the screen shown in FIG. 7B has an input field 25b for inputting any search keyword related to the creator, and is configured to enable a property search based on search keywords such as part of the name of the creator or part of the name of the organization to which the creator belongs.

The control unit 21 determines whether or not the input of search criteria has been accepted via the criteria input screen (S14). Here, the control unit 21 determines whether or not input of a search keyword has been accepted via the input field 25a in the screen shown in FIG. 7A, and whether or not input of search criteria for the category has been accepted via the criteria input screen for the category selected via the screen shown in FIG. 7A. Note that, the input of the search criteria via the criteria input screen for each category determines whether or not input of a search keyword has been accepted via an input field on the screen (input field 25b in FIG. 7B) and whether or not the search criteria (creator in FIG. 7B) has been selected via a check box on the screen (creator check box in FIG. 7B).

When the control unit 21 determines that the input of search criteria has been accepted (S14: YES), it displays the accepted search criteria (S15). For example, when a search keyword is input in the input fields 25a and 25b, the control unit 21 displays the input search keyword in the input fields 25a and 25b. Further, when selecting the search criteria via a check box on the criteria input screen for each category, the control unit 21 displays a check mark in the check box for the selected search criteria. When it is determined that the input of search criteria has not been accepted (S14: NO), the control unit 21 skips the process of step S15, and determines whether or not the search button on the criteria input screen has been operated (S16). When determined that the search button has not been operated (S16: NO), the control unit 21 returns to the process of step S14 and continues to accept input of search criteria.

When determined that the search button has been operated (S16: YES), the control unit 21 transmits the search criteria input via the criteria input screen to the server 10 (S17) and requests the execution of a search process based on the search criteria. When the control unit 11 of the server 10 is requested by the user terminal 20 to execute a search process, the control unit executes the search process by using the search criteria acquired from the user terminal 20 (S18). Specifically, the control unit 11 acquires any search keyword or search criteria related to each category from the user terminal 20, and searches whether there is a property in which the acquired information for the search criteria is included in the information of each property stored in the property information DB 12a. For example, when the control unit 11 acquires an arbitrary search keyword, the control unit searches for properties that include the acquired search keyword in any of the information stored in the property information DB 12a. Further, when the control unit 11 acquires the search criteria related to an address, the properties that match the address in the search criteria are searched, and when the control unit acquires the search criteria related to train lines and stations, the properties that match the train lines and stations in the search criteria are searched. Further, when the control unit 11 acquires the search criteria related to building names, the properties that match the building names in the search criteria are searched, and when the control unit acquires the search criteria related to school districts, the properties that match the school districts in the search criteria are searched. Furthermore, when the control unit 11 acquires the search criteria related to the creator, the properties that match the creator in the search criteria, that is, properties for which the video content was shot by the creator are searched.

The control unit 11 generates a search result screen (not shown) that displays the information about the searched properties (S19), and transmits the generated search result screen to the user terminal 20 (S20). The search result screen is a screen that displays a list of information on the searched properties, and displays only simple information such as the location, building name, price, and the like for each property. The order in which each property is displayed on the search result screen may be any order, and for example, the property with more items that match the search criteria may be ranked higher, or the property with the shortest travel time from the nearest station may be ranked higher. Further, a priority may be set for each item of the search criteria in advance or according to an instruction from the viewer, and properties matching items with higher priority may be ranked higher.

The control unit 21 of the user terminal 20 acquires the search result screen transmitted by the server 10 and displays on the display unit 25 (S21). The search result screen is configured so as to accept the selection of any of the searched properties, and the control unit 21 determines whether or not any of the properties has been selected on the search result screen (S22). If the control unit 21 determines that no property has been selected (S22: NO), the control unit waits until a property is selected, and if it determines that any property has been selected (S22: YES), the control unit requests the information about the selected property from the server 10 (S23).

The control unit 11 of the server 10 reads out the property information corresponding to the request from the user terminal 20 from the property information DB 12a, and generates the property screen as shown in FIG. 8 (S24). Specifically, the control unit 11 reads out the address, building name, location information, building information, price, and video content of the property from the property information DB 12a, and generates the property screen that displays each piece of the read-out information. The screen shown in FIG. 8 has a video area 25c where a main video, for example, that a video content of entering the property from the entrance and showing each room in the property, is displayed, and a thumbnail area 25d where thumbnail images of video content other than the main video are displayed. The video area 25c displays an indicator showing the playback position relative to the recording time (20 seconds in FIG. 8), and is provided with a playback/stop button B1 for instructing playback and stopping of the main video, a fast-forward button B2 for instructing fast-forward, and a fast-rewind button B3 for instructing fast-rewind. The video content which the thumbnail image is displayed in the thumbnail area 25d may be a still image or a video, and in the case of a video, the first image may be displayed as the thumbnail image. The video content includes images of the appearance of the property, images such as roads, parks, and commercial facilities surrounding the property, images such as bicycle parking area and car park on the grounds of the building, images of the building such as entrance of the building, mailbox, entrance hall, elevator hall, and images of interior of the property such as entrance porch, entrance door, washroom, bath, washing machine pan, kitchen, toilet, and each room. Further, the screen shown in FIG. 8 displays information about the creator who shot (produced) the video content in correspondence with the video content.

The control unit 11 transmits the generated property screen to the user terminal 20 (S25), and the control unit 21 of the user terminal 20 acquires the property screen transmitted by the server 10 and displays on the display unit 25 (S26). The property screen shown in FIG. 8 is configured so as to accept the selection for each thumbnail image, and the user selects the thumbnail image of the video content that the user wishes to view. The control unit 21 determines whether or not any video content (thumbnail image) has been selected on the property screen (S27), and if the control unit determines that no video content has been selected (S27: NO), the control unit waits until a selection is made. When the control unit determines that any video content has been selected (S27: YES), the control unit 21 requests the selected video content to the server 10 (S28). The control unit 11 (output unit) of the server 10 reads out the video content requested by the user terminal 20 from the property information DB 12a (S29), and transmits the read-out video content to the user terminal 20 (S30). Then, the control unit 11 adds 1 to the number of views of the video content of the played main video in the status DB 12b, and updates the number of views and viewing history of the main video by storing the date and time of this occasion in the viewing history (S31). Note that, the property screen is configured so as to receive a playback instruction for the video content of the main video displayed in video area 25c. When the control unit 21 of the user terminal 20 receives the playback instruction of the main video, the control unit starts a playback process of the main video and notifies the server 10 that the main video has been played. In this case, the control unit 11 of the server 10 adds 1 to the number of views of the video content of the played main video in the status DB 12b, and updates the number of views and viewing history of the main video by storing the date and time of this occasion in the viewing history.

Note that, when the video content of a video is played, the control unit 21 of the user terminal 20 may, in addition to playing the video content, measure the time the viewer has viewed the content (e.g., 10 seconds from the start of playback) and notify the measured viewing time to the server 10. In this case, the control unit 11 of the server 10 can acquire the portion (time) of the video content of the moving image that has been played and store in the status DB 12b.

The control unit 21 of the user terminal 20 acquires the video content transmitted by the server 10 and displays on the property screen (S32). For example, the control unit 21 displays the acquired video content by overlaying on the property screen. Thereby, the video content selected via the thumbnail image to be can be displayed in the enlarged form, and the user can view any video content. Note that, the video content selected via the thumbnail image may be a still image or a video, and when selecting the video, the control unit 21 plays back the video content acquired from the server 10. The control unit 21 determines whether or not to end the above-mentioned process (S33). For example, when an end button (not shown) provided on the property screen is operated, the control unit 21 accepts the instruction from the user to end the process and determines to end the above-mentioned process.

If the control unit 21 determines not to end the processing (S33: NO), for example, the control unit returns to the processing of the step S27, and each time when any video content is selected on the property screen (S27: YES), the control unit 21 and the control unit 11 of the server 10 perform the processing of the steps S28 to S32. If determined that the process is to be ended (S33: YES), the control unit 21 ends the series of processes. Note that, the property screen shown in FIG. 8 has a “Go to inquiry form” button for instructing the user to move to the inquiry form configured to enable inquiries about the property being displayed, and a “Go to contract form” button for instructing the user to move to the contract form configured to enable procedures related to a contract for the property being displayed. When the “Go to inquiry form” button is operated on the property screen, the control unit 21 acquires an inquiry form from the server 10 and displays on the display unit 25. The inquiry form has an input field for questions about the property and an input field for information about the user (viewer) making the inquiry, and the control unit 21 transmits the inquiry information entered via the inquiry form to the server 10. Thereby the user who has been viewing the property information to make the inquiry about the viewed property. When the control unit 11 of the server 10 receives the inquiry information via the inquiry form, the control unit transmits (transfers) the inquiry information to the real estate company that manages the property or to the person in charge at the real estate company. Further, the control unit 11 adds 1 to the number of inquiries corresponding to the property for which inquiry information was received in the status DB 12b, and updates the number of inquiries and inquiring history for the property by storing the date and time of this occasion in the inquiring history for the property.

Furthermore, when the “Go to contract form” button is operated on the property screen, the control unit 21 acquires the contract form from the server 10 and displays on the display unit 25. The contract form displays the information regarding the contract procedures for the property and has input fields for the contract information required for the contract. Note that, the contract here may be a purchase contract for a real estate property or a rental contract. The control unit 21 transmits the contract information input via the contract form to the server 10. Thereby the user who has viewed the property information to apply for the contract for the viewed property. When the control unit 11 of the server 10 receives the contract information via the contract form, the control unit transmits (transfers) the contract information to the real estate company that manages the property or to the person in charge at the real estate company. Note that, the server 10 may be configured so as to automatically determine whether the contract can be concluded based on the received contract information, and in this case, the contract may be concluded when the server 10 determines that the contract can be concluded. When the contract is concluded, the control unit 11 updates, in the status DB 12b, the contract status corresponding to the property for which the contract has been concluded to “contract completed.” Through the above mentioned processing, the server 10 can provide the property information via the property search site 12S, and can collect the information on viewers' viewing status of the video content of each property, viewers' inquiries regarding each property, and contract status for each property. The server 10 is configured so as to perform the processing to calculate the evaluation score to evaluate each creator based on the viewing status of the video content of each property, the inquiry status regarding each property, and the contract status for each property collected by the above-mentioned processing.

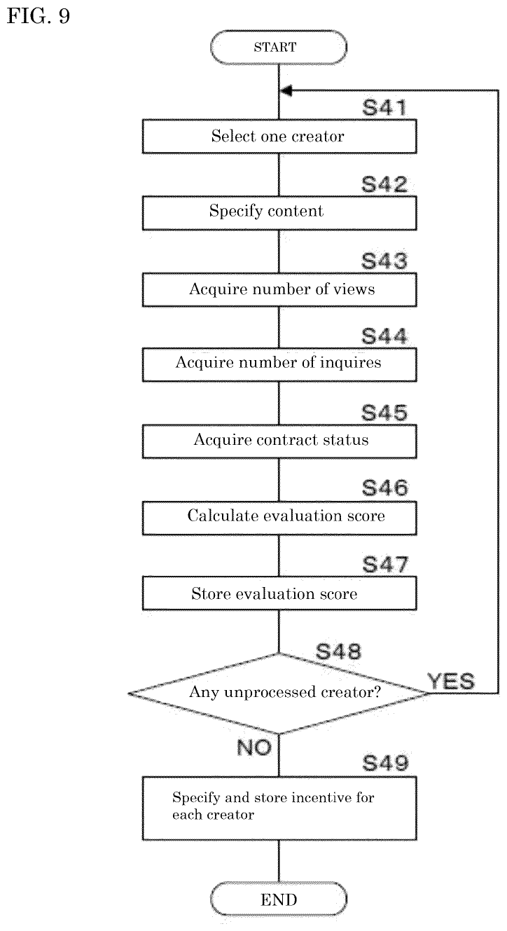

FIG. 9 is a flowchart showing an example of a creator evaluation process. The following processing is performed by the control unit 11 of the server 10 in accordance with the program 12P stored in the storage unit 12. In the information processing system of this embodiment, the server 10 periodically performs a process of calculating the evaluation score for each creator, for example, once a week, once a month, or the like. Therefore, the control unit 11 of the server 10 executes the following process at a predetermined time, such as once a week or once a month, to evaluate each creator. Note that, the control unit 11 may execute the following process in accordance with an operational instruction from the user via the input unit 14.

The control unit 11 selects one of the creators registered in the creator DB 12c (S41), and specifies the video content shot (produced) by the selected creator (S42). For example, the control unit 11 searches for information on the selected creator (e.g., creator ID, name, etc.) from the content information of each property stored in the property information DB 12a, and specifies the video content shot by the selected creator. Note that, when all the video content of one property is shot by one creator, the control unit 11 may specify the property for which the selected creator shot the video content.

The control unit 11 acquires the number of times of each of the specified video contents has been viewed from the status DB 12b (S43). Note that, when the viewing time of each viewer for each video content can be calculated from the viewing history of each video content stored in the status DB 12b, the control unit 11 may calculate the total viewing time in addition to the number of times of each of the viewed video content. Further, the control unit 11 acquires the number of inquiries for the property of each specified video content from the status DB 12b (S44). Furthermore, the control unit 11 acquires the contract status (whether or not a contract has been concluded) for each specified property of the video content from the status DB 12b (S45).

Next, the control unit 11 calculates the evaluation score for each creator according to the number of views, the number of inquiries, and the contract status of each video content (S46). For example, the control unit 11 calculates a view score according to the number of views, an inquiry score according to the number of inquiries, and a contract score according to the contract status, and sets the sum of these as the evaluation score. The view score is calculated, for example, by multiplying the score set for one view by the number of views, and the inquiry score is calculated, for example, by multiplying the score set for one inquiry by the number of inquiries. Further, a predetermined score is added to the contract score when the contract is concluded. Note that, in addition to adding a predetermined score for each view, the view score may be calculated by weighting each view according to the time of the view. For example, by weighting more heavily the closer the viewing time is to the present, a high evaluation score can be calculated for the video content viewed recently. Further, the closer the viewing time is to the posting start date, the heavier the weighting may be, and in this case, a high evaluation score can be calculated for the video content that is viewed immediately after the posting start date. Further, when the total viewing time for each video content can be calculated, the view score may be calculated by multiplying the score per unit time by the calculated total viewing time. Similarly, in addition to adding a predetermined score to each inquiry, the inquiry score may also be calculated by weighting each inquiry according to the time of the inquiry.

The control unit 11 stores the calculated evaluation score in the creator DB 12c in correspondence with the creator ID of the creator selected in step S41 (S47). Then, the control unit 11 determines whether or not there are any creator for whom the evaluation score has not been calculated (unprocessed creator) (S48), and if it determines that there is (S48: YES), the processing returns to the step S41 and executes the processing of the steps S41 to S47 for the unprocessed creator.

If determined that there is no unprocessed creator (S48: NO), the control unit 11 specifies the incentive to be given to each creator based on the evaluation score of each creator stored in the creator DB 12c. Then, the control unit 11 stores the specified incentive content in the creator DB 12c in correspondence with the creator ID (S49). Thereby, the control unit 11 (granting unit) can give the incentives to creators according to the evaluation score and the incentives according to the conclusion of a contract for the property. The contents of the incentives according to the evaluation scores and the conclusion of the contract are stored in advance in the storage unit 12, and the control unit 11 can specify the incentives to be given to each creator based on the contents stored in the storage unit 12. In the above-mentioned process, a contract score according to the contract status is added to the evaluation score of the creator, and the content of the incentive is specified according to the finally calculated evaluation score. In addition to this configuration, the evaluation score of the creator may be the sum of the view score and the inquiry score, and the creator may be given an incentive according to this sum of the evaluation score and an incentive according to the contract status. Even in this case, an incentive can be given to the creator who produced the video content of the property, depending on the contract status of the property.

In this embodiment, in the information processing system that provides the property information via the network N, the creator who produced the video content of each property can be evaluated based on the viewing status of the video content of each property, the inquiry status and the contract status of each property. Further, since the incentive can be given to each creator according to the evaluation content, it is expected that motivation of the creators will increase. As a result, it is possible to collect the attractive video content that will catch the eye of contract seekers and lead to a contract or viewing, thereby increasing the value of the video content of properties provided on the property search site 12S. therefore, it is possible to provide high-quality video content as property information.

The configuration of this embodiment can be applied not only to the information processing system that provides video content of real estate properties via the network N, but also to an information processing system that searches for various objects via the network N and provides video content of the objects as the search results. Even when applied to such an information processing system, the server 10 can search for objects according to search criteria acquired from the user terminal 20 and provide search results, as well as collect information on the viewers' viewing status of the video content of each object, the viewers' inquiries regarding each object, and the contract status for each object (e.g., purchase status, etc.). Therefore, the server 10 can calculate the evaluation score to evaluate each creator based on the viewing status of the collected video content of each object, the inquiry status regarding each object, and the contract status for each object, and can give each creator an incentive according to the evaluation score.

### Embodiment 2

There is explained an information processing system where, when displaying at the top of search results based on the search criteria input on the user terminal 20, the property for which highly evaluated creators have produced the video content. The information processing system of this embodiment can be realized by the same device as the information processing system of the embodiment 1, so explanation of the configuration will be omitted.

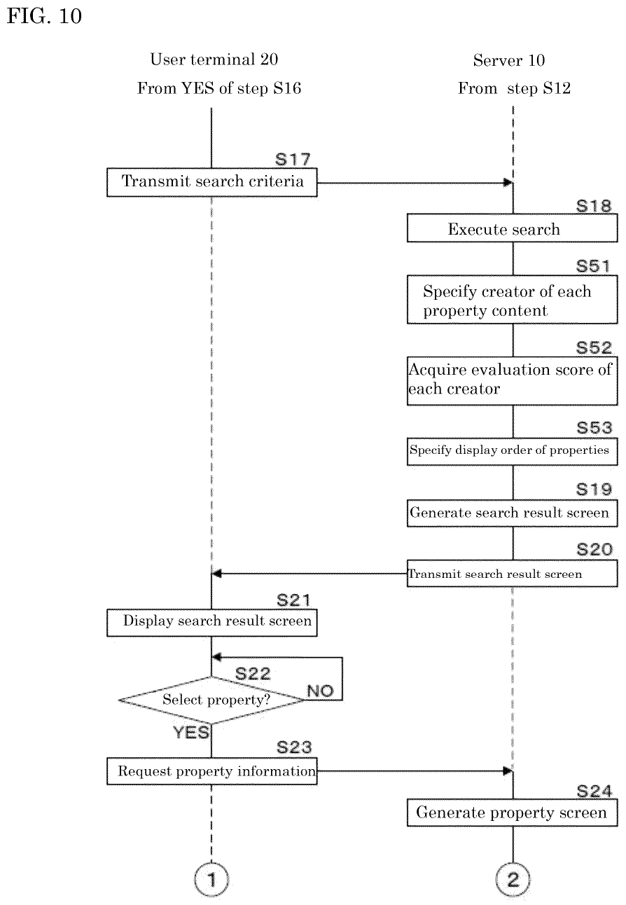

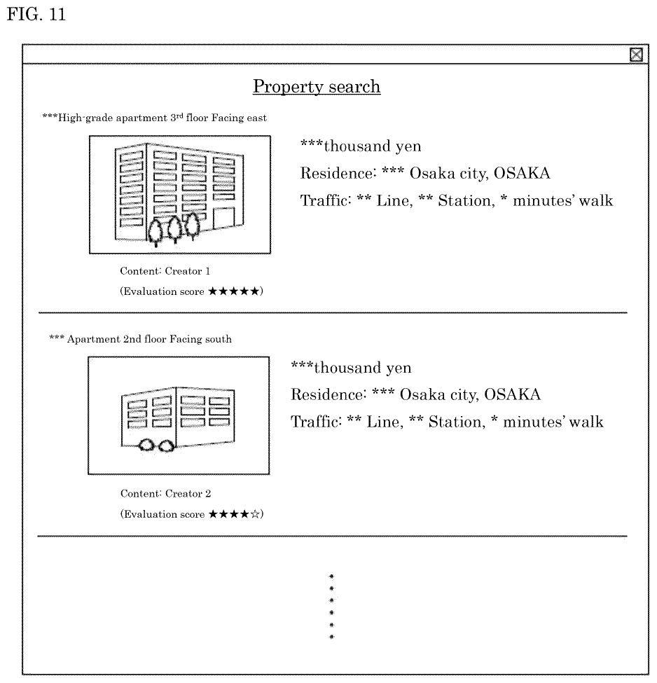

FIG. 10 is a flowchart showing an example of a property search processing procedure according to the embodiment 2, and FIG. 11 is a schematic diagram showing an example of a screen of the user terminal 20. The process shown in FIG. 10 is the process shown in FIG. 5 and FIG. 6 in which the steps S51 to S53 are added between the steps S18 and S19. Explanation of the same steps as those in FIG. 5 and FIG. 6 will be omitted. Further, in FIG. 10, the steps S11 to S16 in FIG. 5 and each steps in FIG. 6 are omitted.

In the information processing system of this embodiment, the user terminal 20 and the server 10 perform the same processes as the steps S11 to S18 in FIG. 5. Then, for each of the searched properties, the control unit 11 specifies the creator who produced the video content of the property based on the content information stored in the property information DB 12a (S51). Note that, when one creator produces all the video content for one property, one creator will be specified, but when different creators produce each video content, the creator of each video content may be specified, for example, the creator who produced the video content for the main video may be specified as the representative creator.

The control unit 11 acquires the evaluation score of the creator specified for each property from the creator DB 12c (S52). Then, the control unit 11 determines the display order (output order) of the searched properties so that the higher the creator's evaluation score, the higher the display order (S53). The control unit 11 generates a search result screen displaying information about each property according to the determined display order of each property (S19), and transmits the generated search result screen to the user terminal 20 (S20). FIG. 11 shows an example of the search result screen, and the search result screen shown in FIG. 11 displays the simple information about the searched properties in descending order of the evaluation scores of the creators who produced the video content of each property. In the example shown in FIG. 11, in addition to the location of each property, the building name, the price, the name of the train line along which the nearest station is located and the name of the station, and the like, the video content from which the main video was shot (produced), the information about the creator who produced the video content, and evaluation information about the creator are displayed. The evaluation information of the creator is expressed, for example, by the number of stars according to the evaluation score, and is expressed by five black stars for the evaluation score equal to or greater than a first threshold, four black stars for the evaluation score equal to or greater than a second threshold (second threshold<first threshold) and less than the first threshold, three black stars for the evaluation score equal to or greater than a third threshold (third threshold<second threshold) and less than the second threshold, two black stars for the evaluation score equal to or greater than a fourth threshold (fourth threshold<third threshold) and less than the third threshold, and one black star for an evaluation score less than the fourth threshold. Note that, the creator evaluation information may be displayed as the evaluation score it is. Thereby, the viewers know not only about the property, but also about the creator who produced the video content of the property, which is expected to increase the number of views of the video content and the number of inquiries about the property depending on the creator.

In this embodiment, the same effects as those of the embodiment 1 described above can be obtained. Further, in this embodiment, the information on properties in the search results can be presented in descending order of the evaluations of the creators who produced the video content of each property. Therefore, it makes possible to preferentially present the property information about properties for which highly evaluated creators have produced video content, which is expected to lead to an increase in job requests to highly evaluated creators and an increase in motivation of the creators.

The configuration of this embodiment is applicable to the information processing system of the embodiment 1 described above, and even when applied to the information processing system of the embodiment 1, similar processing can be performed and similar effects can be obtained. Further, in this embodiment as well, the modified examples described in the above-mentioned embodiment 1 can be applied as appropriate.

### Embodiment 3

An information processing device that assists in the shooting of video content of real estate properties to be posted on the property search sites and the like will be described. The information processing system of this embodiment includes the server 10 and the user terminal 20 similar to those of the information processing system of the embodiment 1, as well as a shooting terminal for shooting the video content, and each device is communicatively connected via the network N.

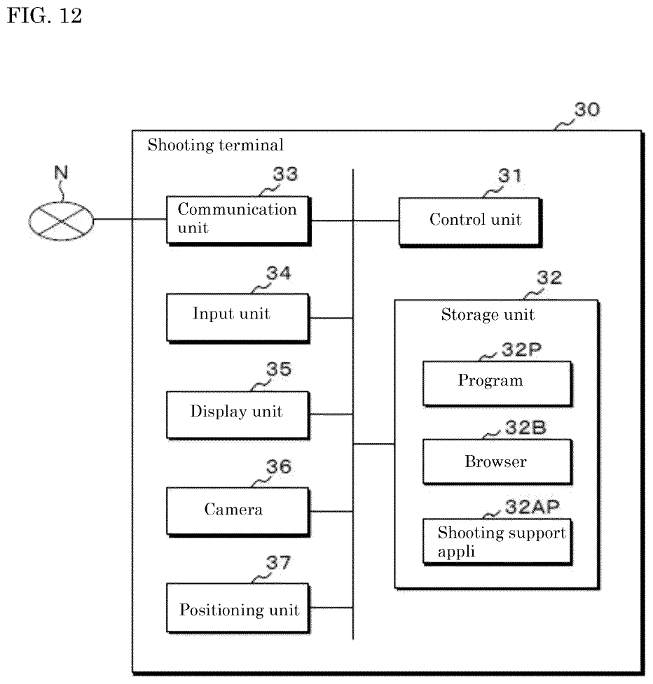

FIG. 12 is a block diagram showing an example of the configuration of the shooting terminal. The shooting terminal 30 is an information processing device that has a function of shooting moving images and still images and is capable of various information processing and information transmission/reception, and is an image capturing device, a smartphone, a tablet terminal, a personal computer, or the like. The shooting terminal 30 is a device used by a creator who produces video content of the real estate properties, and may be any device as long as it is a mobile terminal with a shooting function. The shooting terminal 30 includes a control unit 31, a storage unit 32, a communication unit 33, an input unit 34, a display unit 35, a camera 36, a positioning unit 37, and the like, and these units are connected to each other via a bus. Since the control unit 31, storage unit 32, communication unit 33, input unit 34, and display unit 35 of the shooting terminal 30 have the same configuration as the control unit 11, storage unit 12, communication unit 13, input unit 14, and display unit 15 of the server 10, their explanations are omitted. The storage unit 32 of the shooting terminal 30 stores, in addition to the program 32P (program product) and browser 32B executed by the control unit 31, an application program (hereinafter referred to as the shooting support application 32AP) for supporting the shooting of video content of the real estate properties and for realizing the process of registering the shot video content on the server 10 (property search site 12S).

The camera 36 is a shooting unit having a lens, an image sensor, and the like. The camera 36 shoots pictures in accordance with the instructions from the control unit 31 in response to the operation of the shutter button, and acquires one piece of image data (still image) in response to one shooting instruction, or 30 or 15 pieces of image data (video) per second. The image data (shot image) acquired by the camera 36 is stored in the storage unit 32. The positioning unit 37 detects the current location of the shooting terminal 30 and acquires the current location information (for example, coordinate values of longitude and latitude) indicating the current location. The positioning unit 37 has, for example, a GPS (Global Positioning System) receiver, receives GPS signals transmitted from GPS satellites with the GPS receiver, and detects the current location based on the received GPS signals. Note that, the method for detecting the current location is not limited to the method based on radio waves from GPS satellites. Further, the positioning unit 37 also has a gyro sensor and the like, and acquires the shooting direction of the camera 36 (for example, directions indicated by north, south, east and west). The positioning unit 37 transmits the acquired current location information and shooting direction to the control unit 31.

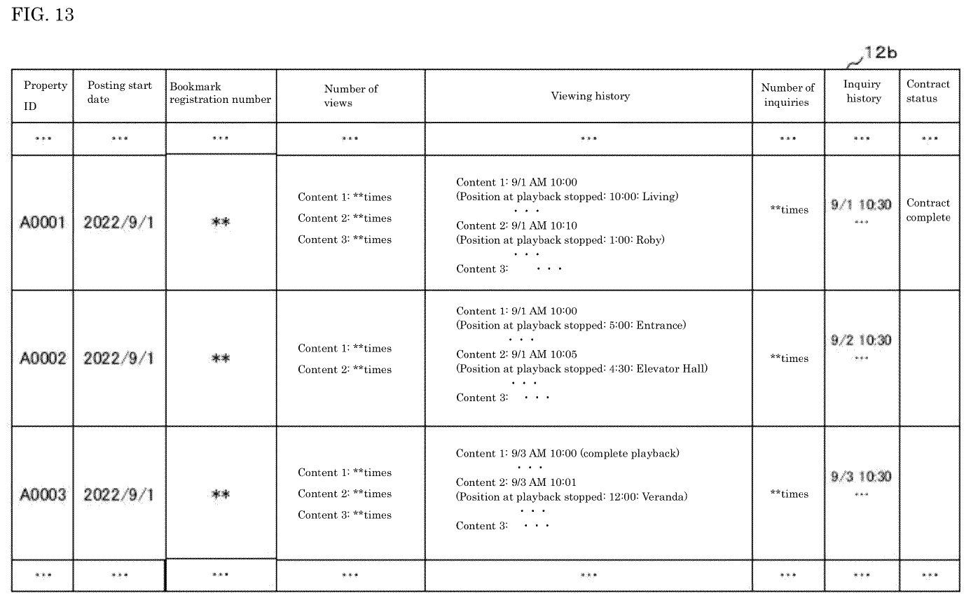

FIG. 13 is an explanatory diagram showing an example of a record layout of the status DB 12b according to the embodiment 3. The status DB 12b shown in FIG. 13 includes a bookmark registration number column in addition to the configuration of the status DB 12b of the embodiment 1 shown in FIG. 4A. The bookmark registration number column stores the number of users who have bookmarked (registered as favorites) the property information posted on the property search site 12S. Note that, the property search site 12S is configured so that each property can be bookmarked. Further, in the status DB 12b of this embodiment, in addition to the date and time when each video content was viewed, the information regarding the position (playback stop position) at which the viewer stopped (ended or interrupted) playback of the video content is stored in the viewing history column. In the video content of this embodiment, an index related to the object being shot in each frame is added to appropriate frames (image frames) in a series of the moving images, and the information regarding the playback stop position includes the time from the start of playback of the video content and the index added to that frame. According to the above-mentioned configuration, the status DB 12b of this embodiment can manage the number of users who have bookmarked each property, and can manage in addition to the viewing status of each video content, the position (frame) at which each viewer stopped (ended) playback of the video content.

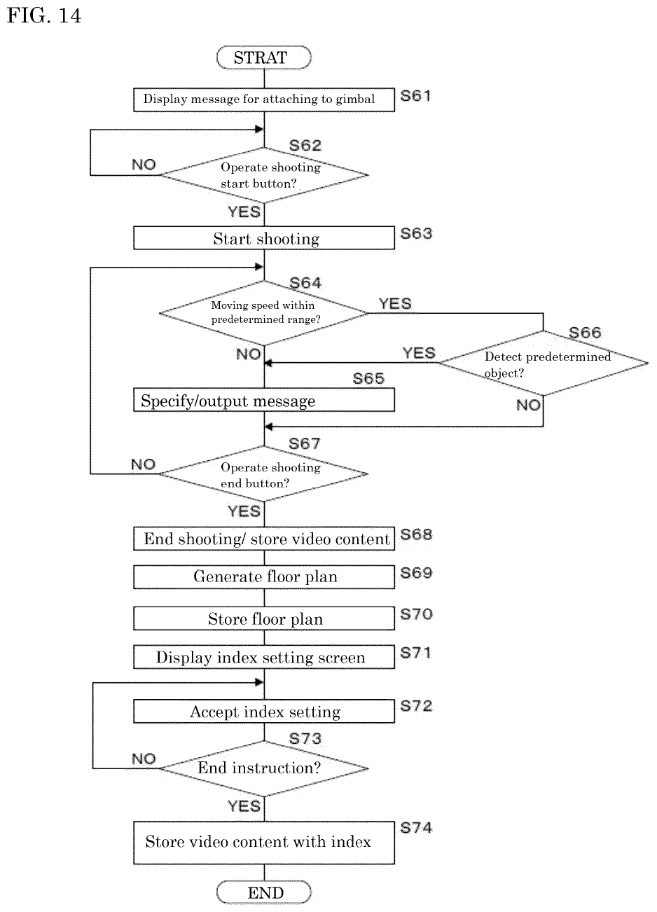

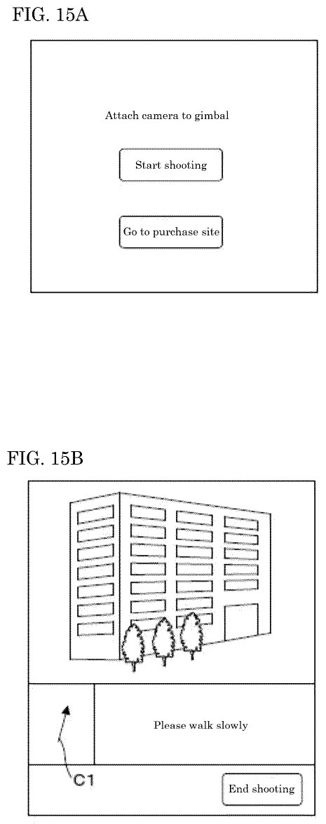

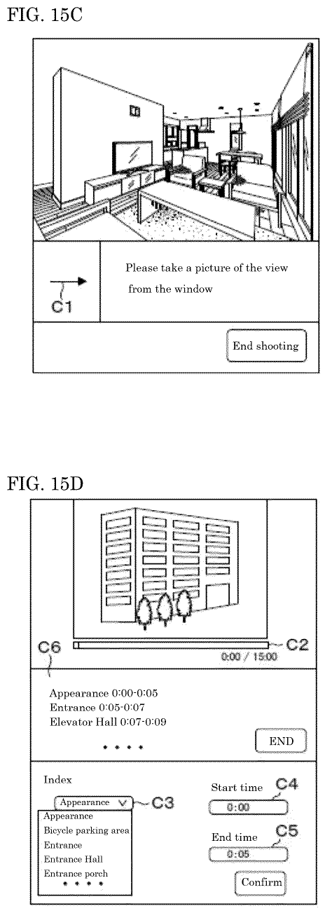

In the following, there is described a process of shooting the video content of a real estate property by using the shooting terminal 30 and adding an index related to the object to be shot to each frame of the shot video content. FIG. 14 is a flowchart showing an example of a shooting process procedure, and FIG. 15A to FIG. 15D are explanatory diagrams showing example screens.

When a creator (shooter) shoots a video content of a real estate property, the creator activates the shooting support application 32AP on the shooting terminal 30, and the control unit 31 of the shooting terminal 30 executes the following processing in accordance with the shooting support application 32AP. First, the control unit 31 displays a message on the display unit 35 to prompt the user to attach the shooting terminal 30 to the gimbal (S61). For example, the control unit 31 displays a screen as shown in FIG. 15A. In addition to the message, the screen in FIG. 15A displays a start shooting button for instructing the user to start shooting video content, and a “Go to purchase site” button for instructing the user to purchase the gimbal. After attaching the shooting terminal 30 to the gimbal, the creator operates the shooting start button to start shooting, or operates the “Go to purchase site” button if the creator does not own a gimbal and would like to purchase one. When the “Go to Purchase Site” button is operated, the control unit 31 accesses a site where gimbals can be purchased and displays a purchase screen of that site, allowing the creator to purchase the gimbal via the site. Note that, some modern mobile phones such as smartphones are equipped with an image stabilization function, so in such cases it is not necessary to install a gimbal.

The control unit 31 determines whether or not the start shooting button has been operated (S62), and if the control unit determines that it has not been operated (S62: NO), it waits, and if the control unit determines that it has been operated (S62: YES), it starts the shooting of the video content (video) with the camera 36 (S63). Here, the control unit 31 shoots, for example, 30 or 15 image frames per second by using the camera 36, and acquires the current location information and the shooting direction by using the positioning unit 37 in synchronization with the shooting timing of each image frame. Thereby, the control unit 31 can acquires the video content in which the shooting position (current location information) and shooting direction are corresponded with each image frame. Note that, the shooting positions and shooting directions are not limited to being corresponded with each image frame, but may be corresponded with every predetermined number (for example, 5, 10, etc.). Further, when the shooting position or shooting direction is changed, the shooting position or shooting direction after the change may be corresponded with the image frame shot at that time.

Further, the control unit 31 calculates the moving speed of the shooting terminal 30 from the detection result of the current location by the positioning unit 37, and determines whether or not the calculated moving speed is within a predetermined range (S64). The predetermined range here is a range of moving speeds that can shoot the video content that allows the viewer to fully grasp the state of the property. If the control unit 31 determines that the moving speed is not within the predetermined range (S64: NO), it specifies and outputs a message in response to the moving speed (S65). For example, if the control unit 31 determines that the moving speed is faster than the predetermined range, the control unit displays a message such as “Please walk slowly” as shown in FIG. 15B. On the other hand, if the control unit 31 determines that the moving speed is slower than the predetermined range, the control unit displays a message such as “Please walk a little faster.” Thereby, the control unit 31 can provide a shooting advice instructing the movement speed during shooting, and the creator can shoot appropriate video content by shooting at the instructed movement speed. Note that, the control unit 31 may detect the shooting condition of the shooter, such as not only the moving speed of the shooter but also the operation speed of pan (panning) operations and tilt (tilting) operations during the shooting, and provide an advice according to the detected shooting conditions. When the shooting terminal 30 has a speaker, the message may be output as voice.

The control unit 31 executes a detection process for a predetermined object on the image frames successively acquired via the camera 36, and if the control unit determines that the moving speed is within the predetermined range (S64: YES), the control unit determines whether or not the predetermined object has been detected in the image frame (S66). The predetermined objects are, for example, windows, faucets, showers, ovens, dishwashers, cupboards, storage shelves, closets, shoe cabinets, and the like, and are the locations and objects that the contract seeker would want to check when signing the contract for the property. The detection process of the object can be executed by using a learning model composed of object detection algorithms such as, for example, CNN (Convolutional Neural Network), SSD (Single Shot Multibox Detector), and YOLO (You Only Look Once), or algorithms that realize semantic segmentation such as SegNet, FCN (Fully Convolutional Network), and U-Net.

If the control unit 31 determines that the predetermined object has been detected in the image frame (S66: YES), the control unit specifies and outputs a message corresponding to the detected object (S65). For example, when the control unit 31 detects a window in the image frame, the control unit displays a message such as “Please take a picture of the view from the window” as shown in FIG. 15C. Further, when the control unit 31 detects a faucet or shower, the control unit displays a message such as “Please take a picture of the water coming out.” Further, when the control unit 31 detects an oven or a dishwasher, the control unit displays a message such as “Please take a picture so that the inside can be seen.” Further, when the control unit 31 detects a cupboard, a storage shelf, a closet, or a shoe cabinet, the control unit displays a message such as “Please open the door and take a picture.” Furthermore, the control unit 31 may display a message regarding the height of the shooting position based on the position of the object detected in the image frame. Further, when displaying an image frame acquired via the camera 36 on the display unit 35, the control unit 31 may display grid lines superimposed on the image frame. Further, the control unit 31 may be configured so as to automatically widen (zoom out) or narrow (zoom in) the angle of view of the camera 36 based on the object being shot in the image frame.

Further, the control unit 31 specifies a recommended shooting direction based on an object detected in an image frame, and displays a direction indication mark C1 that instructs shooting in the specified shooting direction. FIG. 15B shows a state in which the appearance of a property is being shot from outside, and in this case, the direction in which the property is approached is specified as the recommended shooting direction, and the direction indication mark C1 is displayed to indicate the specified shooting direction. FIG. 15C shows a state in which a living room is being shot. In this case, the direction of the window in the image frame is specified as the recommended shooting direction, and the direction indication mark C1 is displayed to indicate the specified shooting direction. By displaying such a direction indication mark C1, the creator can easily determine the direction to be shot. The creator can shoot an image in an appropriate shooting direction by, for example, holding the shooting terminal 30 so that the direction indication mark C1 on the screen points upward. Further, for example, when the direction indication mark C1 has an angle of more than 90 degrees clockwise or counterclockwise from the upward direction, the control unit 31 may determine that the shooting direction is inappropriate and display a message to instruct the user to redo the shooting process. Furthermore, the control unit 31 may present the order of movement during shooting (shooting order) by setting the order of shooting each object until arriving at the room of the property, such as the appearance of the building of the property, building entrance, lobby, elevator, exterior corridor, and the like, as well as the order of shooting each object inside the room of the property, such as the entrance porch, in front of the entrance, inside the entrance, the indoor corridor, bedroom, bathroom, kitchen, living room, veranda, and the like.

If the control unit 31 determines that a predetermined object has not been detected in the image frame (S66: NO), the control unit determines whether or not the end shooting button has been operated (S67), and if the control unit determines that the button has not been operated (S67: NO), the control unit returns to the step S64 and repeats the processing of the steps S64 to S67. When determines that the shooting end button has been operated (S67: YES), the control unit 31 ends the shooting by the camera 36, and stores the video content shot up to this point in the storage unit 32 (S68).

After completing the shooting process, the control unit 31 automatically creates a floor plan of the property (room) to be shot, for example, based on the current location information and the shooting direction detected by the positioning unit 37 during the shooting (S69). For example, the control unit 31 specifies the trajectory of movement of the creator (shooter) based on the current location information detected by the positioning unit 37 when shooting the interior of the property, estimates the size and shape of each room based on the specified trajectory, and creates a floor plan. At this time, the control unit 31 assigns the position information to an appropriate position on the floor plan based on the current location information of the shooting position. Further, the control unit 31 may measure the distance from the shooting position of each frame to a wall or object inside the room based on each shot frame, estimate the size, shape, and the like of each room, and create a floor plan. Furthermore, when the shooting terminal 30 is equipped with a distance sensor, the distance to the wall or object in the room may be measured by using the distance sensor to estimate the size, shape, and the like of each room and create a floor plan. Further, when the control unit 31 acquires the height from the floor to the ceiling of the property, the control unit may create a floor plan of a 3D model. The control unit 31 stores the created floor plan in the storage unit 32 in correspondence with the video content (S70). Note that, the control unit 31 may create a floor plan while shooting the video content.

Next, the control unit 31 displays an index setting screen as shown in FIG. 15D on the display unit 35 in order to accept an operation to add an index relating to an object to an image frame in the video content acquired by the shooting process (S71). The screen in FIG. 15D displays the video content and an indicator C2 for indicating the playback position of the video content, and is configured so that the playback position of the displayed video content can be changed by moving the playback position via indicator C2. Further, the screen of FIG. 15D has an input field C3 for inputting an index to be added to the image frame, and input fields C4 and C5 for inputting the start time and end time of the image frame to which the index is added. The input field C3 is provided with a pull-down menu for selecting any one of options prepared as an index, and the input fields C4 and C5 are configured to allow input of any time within the shooting time of the video content. The pull-down menu provided in the input field C3 allows the selection of, for example, appearance, bicycle parking area, entrance, entrance hall, entrance porch, lobby, elevator, shared corridor (exterior corridor), shared toilet, garbage disposal area, living room, bedroom, study, bathroom, shower room, veranda, parking lot, gym, swimming pool, and the like.

On the screen of FIG. 15D, the creator confirms the shot contents of the video content while moving the playback position by using the indicator C2, and specifies the first frame and the last frame to which the creator wishes to add an index. Then, the creator inputs the index to be added in the input field C3, inputs the playback time of the first frame in the input field C4, inputs the playback time of the last frame in the input field C5, and operates the confirm button. The control unit 31 accepts the setting of the index through the operation of the creator as described above (S72). When the confirm button is operated, the control unit 31 displays the index information input in the input fields C3 to C5 at this time in the index display field C6.

Then, the control unit 31 determines whether or not an end instruction has been received (S73). For example, the control unit 31 accepts the end instruction when the end button provided in the index display field C6 is operated. If the control unit 31 determines that the end instruction has not been received (S73: NO), the process returns to the step S72, and the control unit continues to receive the setting of the index. Thereby, the control unit 31 can receive, for each index, the playback time (start time and end time) of the frame to which each index is added, and can display the received index information as shown in FIG. 15D. If determines that the end instruction has been received (S73: YES), the control unit 31 stores in the storage unit 32 the indexed video content in which index information has been added to appropriate image frames (S74), and ends the series of processes.

By the above-mentioned processing, the shooting terminal 30 of this embodiment provides messages regarding the moving speed, shooting direction, and shooting object when shooting the property, as well as the height of the shooting position and the order of movement when shooting (shooting order). Therefore, by shooting according to the messages, the creator can produce high-quality video content without relying on the shooting skill or sense of the creator. Further, the index relating to the shot object can be added to each frame of the video content of the property. Furthermore, it is possible to automatically create a floor plan of the property being shot. Note that, in the above-mentioned process, the process of shooting the video content in the steps S61 to S70 and the process of adding the index in the steps S71 to S74 may be performed by different devices. For example, it is an allowable configuration that the creator may perform the shooting process of the video content, and the owner of the property or the person in charge at a real estate company may perform the index adding process. Further, the video content may be shot by a shooter who holds the gimbal to which the imaging terminal 30 is attached, or may be shot by using a drone with shooting capabilities. In this case too, high-quality video content can be obtained by operating the drone according to the messages provided by the shooting terminal 30. Further, it is an allowable configuration that the floor plan is not limited to being automatically created by the shooting terminal 30, and may be acquired by the shooting terminal 30 from a floor plan created by another device.

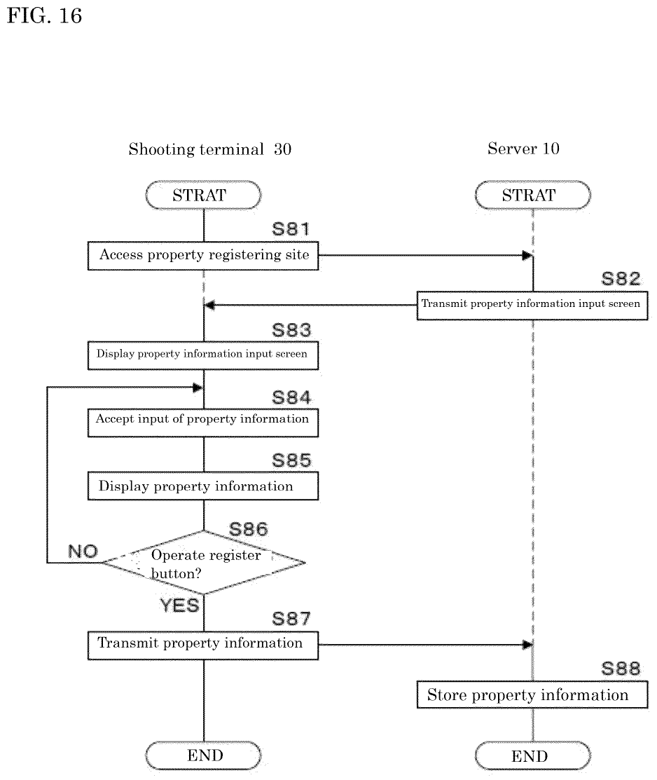

In the following, the process of registering the property information on the property search site 12S will be described. FIG. 16 is a flowchart showing an example of a property information registration process. In FIG. 16, the left side shows the process performed by the shooting terminal 30, and the right side shows the process performed by the server 10, respectively. The process in FIG. 16 will be described with reference to the configuration in which the property information is registered in the server 10 by using the shooting terminal 30 that shot the video content, but the present invention is not limited to such a configuration. For example, the owner of the property or the person in charge at a real estate company may register the property information in the server 10 by using a terminal other than the shooting terminal 30.

A registrant who registers the property information (for example, the owner of the property or the person in charge at the real estate company) uses the shooting terminal 30 to access the property registration site provided by the server 10 and performs the process of registering the property information via the property registration site. When the control unit 31 of the shooting terminal 30 receives an instruction to access the property registration site via the input unit 34, the control unit starts the browser 32B and accesses the property registration site (S81). Note that, the control unit 31 may be configured to access the property registration site by activating the shooting support application 32AP. The control unit 11 of the server 10 transmits a web page in response to the request from the shooting terminal 30, in this case an input screen for property information to be posted on the property search site 12S, to the shooting terminal 30 (S82). The control unit 31 of the shooting terminal 30 receives the web page transmitted by the server 10, and displays an input screen (not shown) for the property information on the display unit 35 based on the received web page (S83).

The input screen of the property information has input fields for various pieces of information, including basic information such as desired price (rent, selling price, etc.), location, building name, contact information, location information regarding the location of the property, building information regarding the building of the property and rooms, and content information regarding the video content and floor plan.

Further, the input screen of the property information will display messages such as “If you enter more information, it will be easier to search for properties,” to encourage users to actively enter each piece of information. Note that, the building information includes the size of the property, the layout, the year of construction, the orientation of the veranda or balcony, the number of floors of the building and the floor of the property, as well as whether it is an apartment building or a detached house, whether it has a garden or a parking lot, whether there is a pool or a training gym available, the internet environment, and whether there are facilities such as air conditioning equipment and cooking equipment, and by registering such detailed information, it becomes easier to match the property in the search results when searching for properties.

The control unit 31 accepts the input of property information via the input screen of the property information (S84), and displays the input property information in each input field (S85). Note that, the file names of the video content and the floor plan are input. The input screen is provided with a registration button for issuing an instruction to register the input property information in the server 10, and the control unit 31 determines whether or not the registration button has been operated (S86). If determines that the registration button has not been operated (S86: NO), the control unit 31 returns to the step S84 and continues accepting input of property information. If determines that the registration button has been operated (S86: YES), the control unit 31 transmits the input property information to the server 10 (S87). The control unit 11 of the server 10 issues the property ID, and stores the property information received from the shooting terminal 30 in the property information DB 12a in correspondence with the property ID (S88).

In the above-mentioned process, after the shooter shoots the video content of the property by using the shooting terminal 30, the property information including the video content is registered in the server 10, but the present invention is not limited to such a configuration. For example, the owner of the property or the person in charge at a real estate company may use the own terminal to execute the process of FIG. 16 to register the property information other than the video content on the server 10, and a creator requested by the owner of the property or the person in charge at a real estate company may shoot the video content of the property by using a shooting terminal 30 and register the video content on the server 10. Note that, when requesting a creator to shoot video content, the client provides the creator with the property information indicating the location of the property to be shot, the building, and the rooms within the building, as well as shooting conditions such as the desired shooting image and areas that should be focused on for shooting. Further, the server 10 manages, in the creator DB 12c, the evaluation information of each creator and the properties for which each creator has produced video content in the past, and may make this information public. Further, by registering the shooting devices and shooting equipment owned by each creator in the server 10, the shooting devices and shooting equipment owned by each creator may be made public by the server 10. In this case, the client can decide which creator to request by referring to the evaluation information of each creator, the video content that each creator has produced in the past, and the shooting devices and the shooting equipment owned by each creator. Further, the client may display information about the property for which the shooting request is made, for example, on a map, and make it available to the creator. In this case, the creator can be configured to determine the property for which a shooting request is to be received based on the location of the property on the map and the shooting criteria, and the like, and to accept the shooting request from the client.

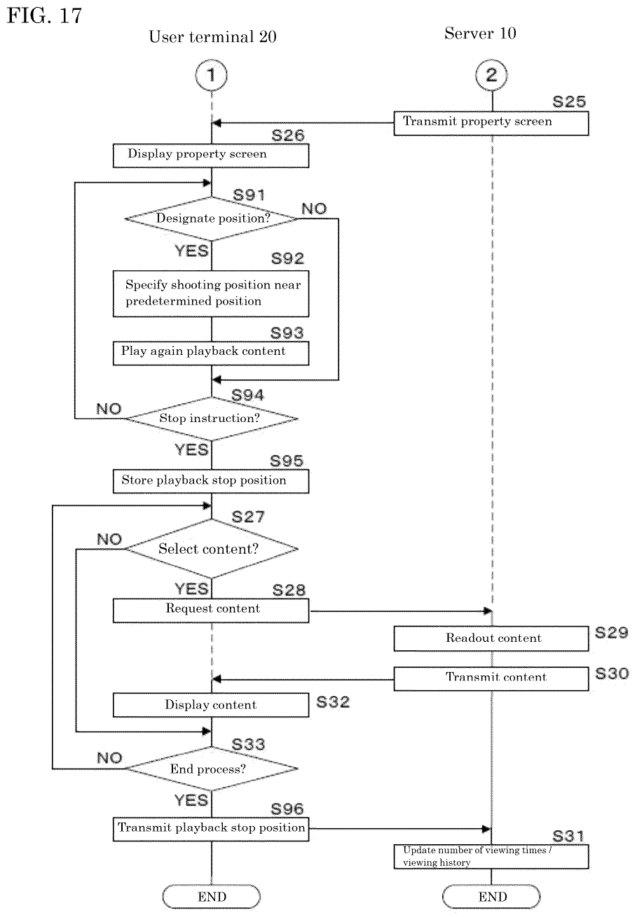

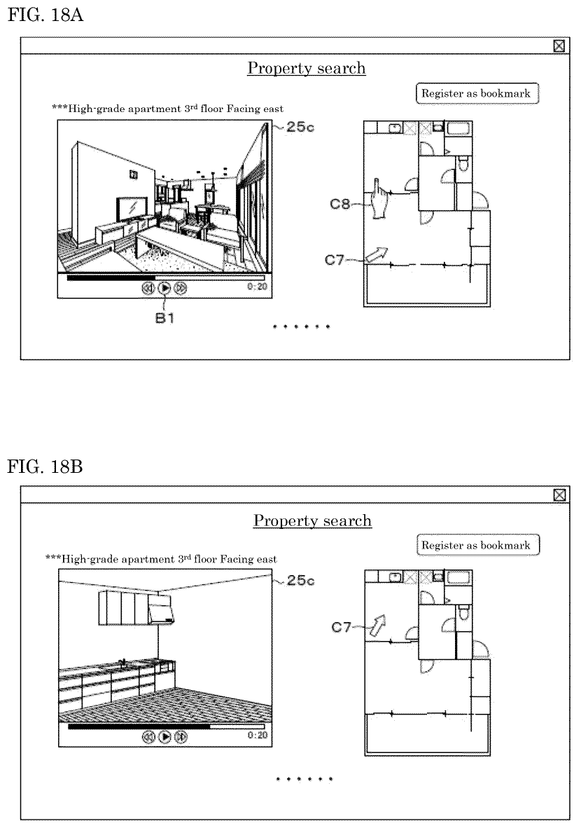

FIG. 17 is a flowchart showing an example of a property search processing procedure according to the embodiment 3, and FIG. 18A and FIG. 18B are schematic diagrams showing examples of screens of the user terminal 20. The process shown in FIG. 17 is similar to the process shown in FIG. 5 and FIG. 6 in that steps S91 to S95 are added between the steps S26 and S27, and the step S96 is added after YES in the step S33. Description of the same steps as those in FIG. 5 and FIG. 6 will be omitted. In FIG. 17, illustration of each step in FIG. 5 is omitted.

The control unit 21 of the user terminal 20 and the control unit 11 of the server 10 in this embodiment execute the same processes as the steps S11 to S26 in FIG. 5 and FIG. 6. Note that, in this embodiment, in the step S24, the control unit 11 of the server 10 generates a property screen as shown in FIG. 18A. The screen of FIG. 18A displays the same information as the screen of FIG. 8, and in addition thereto, a floor plan of the property. The floor plan is stored in the property information DB 12a together with the video content. In the screen of FIG. 18A, information other than the video area 25c and the floor plan is omitted, but similar to FIG. 8, the thumbnail area 25d, property information, creator information, and the like are also displayed. Further, in the step S26, when the control unit 21 of the user terminal 20 displays the property screen, the control unit starts playing the video content (main video) in the video area 25c.

In the video content of this embodiment, a shooting position and a shooting direction are corresponded with each image frame. Further, appropriate positions in the floor plan are corresponded with position information corresponding to the shooting positions of the image frames. Therefore, it is possible to correspond the shooting position of each image frame with a position on the floor plan, and when playing video content, the control unit 21 of the user terminal 20 can specify the shooting position of the image frame being displayed and specify the position on the floor plan that corresponds to the specified shooting position. Further, the control unit 21 can specify the shooting direction at the specified shooting position. Therefore, as shown in FIG. 18A, the control unit 21 of this embodiment is configured to display the video content in the video area 25c, and also to display the mark C7 on the floor plan for indicating the specified shooting direction from the specified shooting position. Further, the property screen of this embodiment is configured so that when an arbitrary position on the floor plan is specified, the video content can be played from an image frame shot at the specified position.

Therefore, after the process of the step S26, the control unit 21 determines whether or not an arbitrary position on the floor plan has been designated (S91). For example, as shown at C8 in FIG. 18A, the control unit 21 accepts the designation of an arbitrary position by the predetermined operation (for example, a touch operation) on the floor plan. If determines that an arbitrary position has been designated (S91:
YES), the control unit 21 specifies the shooting position closest to the designated position from among the shooting positions of each image frame of the video content being played (S92). Then, the control unit 21 resumes the playback of the video content from the image frame shot at the specified shooting position (S93). In this case, as shown in FIG. 18B, the control unit 21 plays the video content from the image frame shot from the designated position in the video area 25c, and in addition thereto, displays a mark C7 for indicating the shooting position and shooting direction on the floor plan. Thereby, the image frames of locations that the viewer desires to see can be efficiently played back. If determines that no arbitrary position has been designated (S91: NO), the control unit 21 skips the steps S92 to S93. Then, the control unit 21 determines whether or not an instruction to stop playback of the video content being played in the video area 25c has been received by operating the playback stop button B1 (S94), and if determines that the instruction has not been received (S94: NO), the control unit returns to the step S91 and repeats the processing of the steps S91 to S94.

If determines that the instruction to stop playback has been received (S94: YES), the control unit 21 stops playback of the video content in the video area 25c, and stores in the storage unit 22 the playback stop position which indicates the image frame where the playback was stopped (S95). The playback stop position includes the elapsed time from the start of the playback of the video content (playback time) and the index of the image frame. Thereafter, the control unit 21 performs the steps S27 to S33, and when any of the video content displayed in, for example, the thumbnail area 25d on the property screen is selected, the control unit 21 acquires the selected video content from the server 10 and displays. If determines that the above-mentioned processing has been ended (S33: YES), the control unit 21 transmits the playback stop position (the playback stop position in the main video) stored in the step S95 to the server 10 (S96), and ends the series of processing. In this embodiment, in the step S31, the control unit 11 of the server 10 adds 1 to the number of times the video content has been viewed in the status DB 12b, and updates the number of times the video content has been viewed and the viewing history by storing the date and time and the playback stop position in the viewing history.

By the above-mentioned process, in this embodiment, when a viewer views the video content of the property, the viewer can ascertain the shooting position and shooting direction within the property from the mark C7 displayed on the floor plan. Further, by designating any position on the floor plan, the video content can be viewed from an image frame that has been shot at that position. Thereby, the viewer can efficiently view the video content and well ascertain the atmosphere of the property. Further, in this embodiment, the server 10 can manage not only the number of times each video content has been viewed and the viewed date and time, but also the position (image frame) at which each viewer stopped (ended) playback.

In this embodiment, for example, on the property screens shown in FIG. 18A and FIG. 18B, a “Register as bookmark” button is provided, and each property is so configured as to be registered as a bookmark (registered as a favorite). When the “Register as bookmark” button on the property screen is operated, the control unit 21 of the user terminal 20 adds the property being displayed on the property screen to a bookmark list on the property search site 12S. Thereby, when the user terminal 20 subsequently accesses the property search site 12S, the viewer can search for the property information from the bookmark list. Further, when a bookmark is registered, the control unit 21 transmits the information about the user of the user terminal 20 and the information about the bookmarked property to the server 10, and notifies that the user has registered a bookmark. When the control unit 11 of the server 10 is notified of bookmark registration from the user terminal 20, the control unit 11 adds 1 to the number of bookmark registrations corresponding to the property ID of the property in the status DB 12b. Note that, the control unit 11 may also store the information about the user who registered the bookmark in the status DB 12b in correspondence with the property ID. Thereby, the user can bookmark the favorable property on the property search site 12S, and also the server 10 can manage the number of bookmarks for each property.

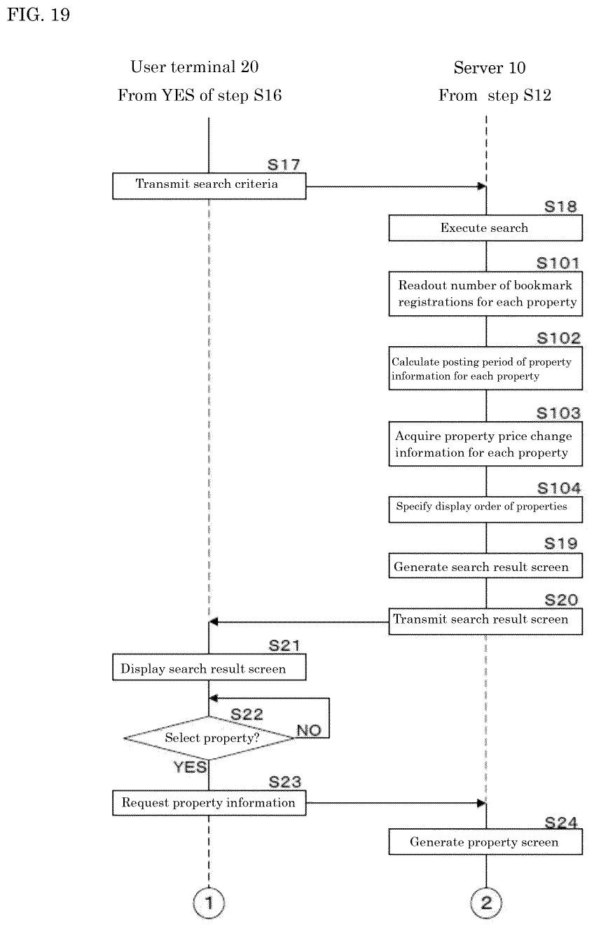

FIG. 19 is a flowchart showing another example of the property search processing procedure. The process shown in FIG. 19 is obtained by adding the steps S101 to S104 between the steps S18 and S19 in the process shown in FIG. 5 and FIG. 6. Description of the same steps as those in FIG. 5 and FIG. 6 will be omitted. Further, in FIG. 19, illustrations of the steps S11 to S16 in FIG. 5 and each step in FIG. 6 are omitted.

In the process shown in FIG. 19, after the process of the step S18, the control unit 11 of the server 10 reads out the number of bookmark registrations for each of the searched properties from the status DB 12b (S101). Further, the control unit 11 calculates the posting period of the property information for each property (S102). Here, the control unit 11 reads out the posting start date of each property from the status DB 12b, and calculates the period from the posting start date to this point in time. Further, the control unit 11 acquires the property price change information for each property (S103). For example, the price of each property can be changed, and in addition to the price of each property, the property information DB 12a registers the date on which each price was set or the date on which each price was made public on the property search site 12S. In this case, the control unit 11 reads out the latest price and the previous price from the property information DB 12a, and calculates the price change information, such as the discount amount or discount rate, or the price increase amount or increase rate.

Then, the control unit 11 specifies the display order (output order) of the searched properties based on the number of bookmark registrations, the posting period, and the price change information (S104). For example, the control unit 11 assigns a higher score to each property having the more bookmarks, the shorter the posting period, and the greater the price fluctuation, and calculates the sum of each score. Then, the control unit 11 determines the display order of each property so that the higher the calculated score for each property, the higher the rank of property will be displayed. Thereafter, the control unit 11 executes the processes from the step S19 onward.

By the above-mentioned processing, the display order of the property information of the properties obtained as search results is determined so that properties with a greater number of bookmarks are ranked higher, properties with a longer time since their information was first posted are ranked lower, and properties with a greater price fluctuation are ranked higher. The posting start date may be registered for each video content in the status DB 12b, and in this case, the control unit 11 may determine the display order taking into consideration the posting period of each video content. Further, the display order may be determined by combining the processes in the steps S51 to S52 in FIG. 10 and taking into consideration the evaluation of the creator of each video content.

In this embodiment, the status DB 12b stores the playback stop position at which each viewer stopped (ended) playback in correspondence with the video content of the property. Therefore, when calculating the evaluation score of the creator, the playback stop position of each video content may be taken into consideration. Specifically, in the process shown in FIG. 9, after the process of the step S45, the control unit 11 of the server 10 acquires the playback stop position of each viewer for the video content specified in step S42 from the status DB 12b. Then, in step S46, the control unit 11 calculates the evaluation score for each creator according to the playback stop position of each viewer in addition to the number of views, the number of inquiries, and the contract status of each video content. The score in correspondence with the playback stop position is calculated, for example, by calculating for each viewer the ratio of playback time (the time until the playback stop position) to the recording time of the video content, assigning a set score to each ratio (the larger the ratio, the higher the score), and then adding up the scores of all viewers. Further, the score in correspondence with the playback stop position may be calculated by calculating the average value of the ratios calculated for each viewer, and a score set for the average value of the ratios (the higher the average value of the ratios, the higher the score). Further, the score in correspondence with the playback stop position may be calculated based on the ratio of the number of played image frames to the number of image frames included in the video content, and a score set for that ratio (the higher the ratio, the higher the score). Furthermore, the score in correspondence with the playback stop position may be calculated by calculating the total playback time (viewing time) of the video content by each viewer and multiplying the score per unit time by the calculated total viewing time. Thereafter, the control unit 11 executes the processes from the step S47 onwards. By the above-mentioned processing, creators can be evaluated based on not only the number of views, number of inquiries, and contract status of each video content, but also the playback stop position of each viewer, and the incentive to be given to the creator can be determined based on the evaluation score calculated for the creator.

In this embodiment, the server 10 may be configured to perform the processing to provide information stored in the status DB 12b, such as the number of bookmarks for each property, the number of views and viewing history of each video content, the number of inquiries and inquiry history for the property, and the contract status of the property, to the owner of the property or the person in charge at a real estate company, or to a creator. In this case, for example, the owner of the property can check the viewing status of each video content along with the number of bookmarks registered for the property, the inquiry status, and the contract status, and can determine whether or not to change the video content depending on the inquiry status and contract status of the property. Further, the creator can confirm not only the viewing status of the video content which is created by the creator, but also the inquiry status and contract status for the property, and can use the inquiry status and contract status for the property as indicators when judging the quality of the own video content. Further, since the viewing status includes the playback stop position, the creator can know at what part (at what scene) of the video content each viewer stopped viewing, and can use this information when creating future video content.

In this embodiment, the server 10 manages the contract status of each property in the status DB 12b. Therefore, the server 10 may perform a process of calculating a fee (brokerage fee) to be paid by the property owner to the property contract intermediary (for example, a real estate company or a company that operates the server 10) when a contract is concluded. For example, when a contract is concluded for any property, the control unit 11 of the server 10 may calculate the posting period for that property on the property search site 12S until the contract is concluded, and calculate a fee in correspondence with the posting period. For example, in the contract criteria column of the status DB 12b, in addition to whether or not a contract for the property has been concluded, the contract conclusion date is stored. Then, the control unit 11 reads out the posting start date and contract conclusion date of the property for which the contract has been concluded from the status DB 12b, calculates the period from the posting start date to the contract conclusion date (posting period), and calculates a lower fee, for example, the shorter the posting period. Note that, regarding whether or not a contract has been concluded, it may be determined that the contract has been concluded, for example, when the control unit 11 stores “contract completed” in the contract status column of the status DB 12b. Further, the brokerage fee may be calculated by taking into consideration not only the period of time that the property was posted on the property search site 12S, but also the number of bookmarks, the viewing status of the video content, the status of inquiries about the property, and the like.

In this embodiment, the property information to be posted on the property search site 12S may be registered not only by the property owner, but also by a real estate company that has been requested (entrusted) by the property owner to mediate a contract or the like. Therefore, the server 10 can also evaluate the real estate companies (agents) based on the contract status of each property stored in the status DB 12b. For example, by registering the information on the agents for each property in the property information DB 12a, the control unit 11 of the server 10 can manage the agents for each property. Then, based on the contents stored in the status DB 12b, the control unit 11 specifies the contract completion status of properties mediated by each agent and the posting period until a contract is concluded for each property, and calculates an evaluation score for each agent based on, for example, the number of contracts concluded, the contract conclusion rate, and the period until a contract is concluded for the property. By calculating the evaluation score of each intermediary or each person in charge of the agent through such processing, it is possible to evaluate and rate each agent or each person in charge. Further, it is possible to set brokerage fees according to the evaluation scores of each agent or each person in charge.

The configuration of this embodiment is applicable to the information processing systems of the embodiments 1 and 2 described above, and even when applied to the information processing systems of the embodiments 1 and 2, similar processing can be performed and similar effects can be obtained. Further, in this embodiment, the modified examples described in the above-mentioned embodiments 1 and 2 can also be applied as appropriate. Further, in the above-mentioned embodiments 1 to 3, the video content of one property may be produced by one creator or may be produced by a plurality of creators. Further, the property owner or the person in charge at a real estate company may select the video content to be posted on the property search site 12S from multiple video contents produced by each creator, and also may employ the configuration such that the posting period for each video content can be set.

In this embodiment, as shown in FIG. 18A and FIG. 18B, video content and a floor plan are displayed on the property screen, making it easy to imagine what the inside of the property will be like. Further, the control unit 11 of the server 10 may, for example, produce the image pictures of furniture such as curtains, sofas, tables, and chairs with respect to the video content on the property screen, and in this case, it is possible to provide a property screen that allows the user to more easily imagine the living space in the property. Further, the property screen may be configured to allow furniture such as curtains and sofas to be virtually arranged in relation to the video content and floor plan, and may be configured to allow the virtually arranged furniture to be purchased or custom-made furniture to be ordered. Furthermore, the property screen may combine an image of the interior designed by an interior coordinator or the like with the video content. Further, by preparing image pictures of interiors designed by a plurality of interior coordinators, the viewer can virtually check the interiors designed by each interior coordinator and place an order if the viewer likes it.

### Embodiment 4

An information processing system in which contract seekers can submit bids (purchase prices) for properties listed on the property search site 12S, and contract applications for the properties for which bids have been submitted (properties for which bids have been submitted) are accepted in the form of bidding for a certain period of time. The information processing system of this embodiment can be realized by the same device as the information processing system of the embodiment 1, so a description of the configuration will be omitted.

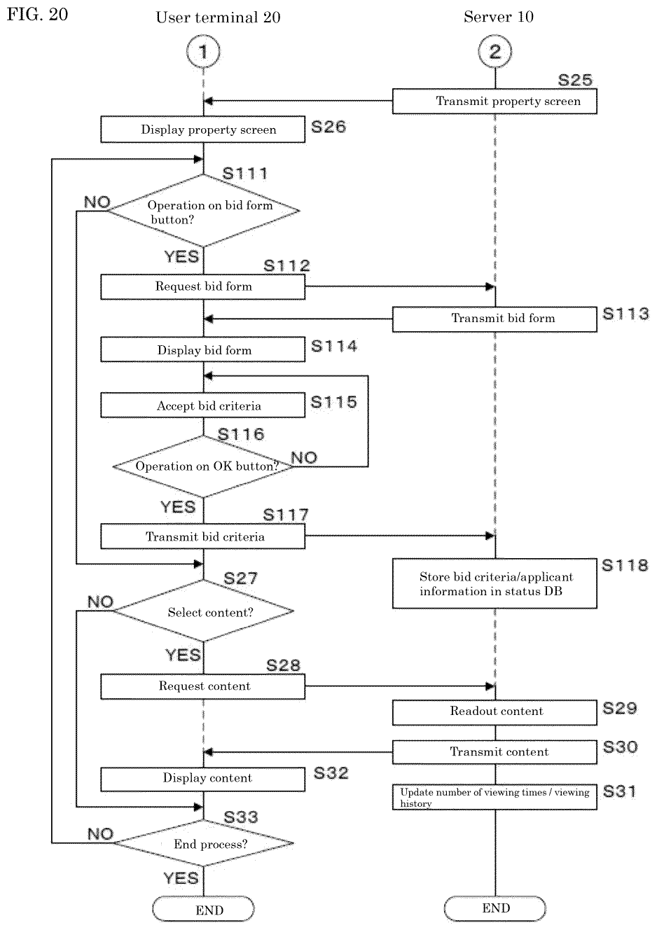

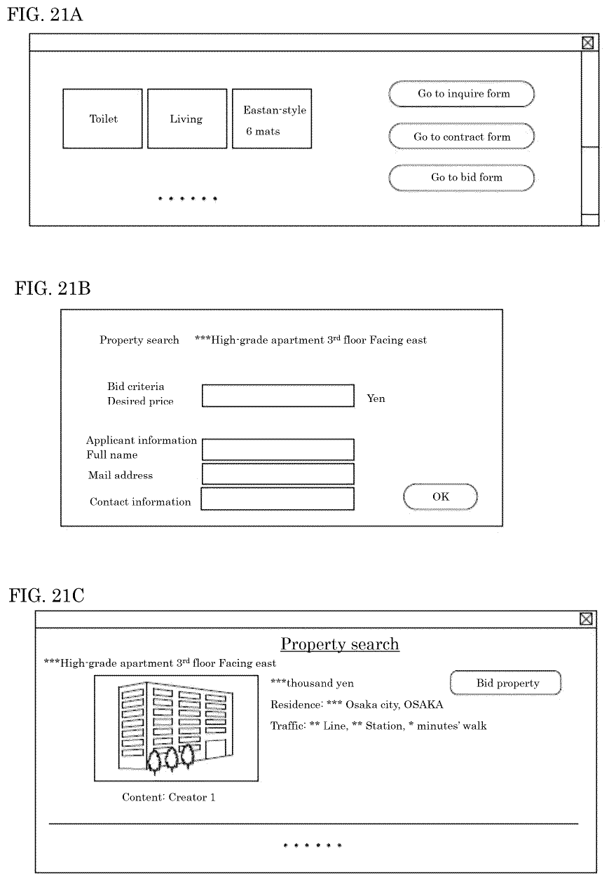

FIG. 20 is a flowchart showing an example of a property search process procedure according to the embodiment 4, and FIG. 21A to FIG. 21C are schematic diagrams showing examples of screens of the user terminal 20. The process shown in FIG. 20 is the process shown in FIG. 5 and FIG. 6, in which the steps S111 to S118 are added between the steps S26 and S27. Description of the same steps as those in FIG. 5 and FIG. 6 will be omitted. In FIG. 20, illustration of the steps in FIG. 5 are omitted.

The control unit 21 of the user terminal 20 and the control unit 11 of the server 10 in this embodiment execute the same processes as the steps S11 to S26 in FIG. 5 and FIG. 6. In this embodiment, in the step S26, the control unit 21 of the user terminal 20 displays a property screen as shown in FIG. 21A. The screen of FIG. 21A has, in addition to the same information as the screen of FIG. 8, a “Go to bid form” button for instructing a transition to a bid form configured to enable procedures regarding bidding for the property being displayed. The screen of FIG. 21A shows only the lower part of the screen of FIG. 8.

When a viewer wishes to make a bid on a property being viewed, the viewer operates the “Go to bid form” button on the property screen. The control unit 21 of the user terminal 20 determines whether or not the “Go to bid form” button has been operated (S111), and if determines that it has not been operated (S111: NO), proceeds to the step S27. In this case, the control unit 21 executes the same processes as those in the embodiment 1 shown in FIG. 5 and FIG. 6. Note that. in the process shown in FIG. 20, if the control unit 21 determines in step S27 that the video content on the property screen has not been selected (S27: NO), the process transfers to the step S33, and if the control unit determines in the step S33 that the process should not be terminated (S33: NO), the process transfers to the step S111.

When the control unit 21 determines that the “Go to bid form” button has been operated (S111: YES), the control unit requests a bid form from the server 10 (S112). The control unit 11 of the server 10 transmits the bid form requested by the user terminal 20 to the user terminal 20 (S113), and the control unit 21 of the user terminal 20 displays the bid form received from the server 10 on the display unit 25 (S114). FIG. 21B shows an example of the bid form, which displays the information about the property (for example, the building name of the property) and has fields for inputting the information required for submitting a bid. The input fields include an input field for information of a user (applicant) who wishes to submit a bid, an input field for bid criteria, and the like. The applicant information includes the name of the applicant, email address, contact information, and the like, and the bid criteria include the desired contract price (desired rent, desired purchase price) of the bidding applicant. Note that, the bid form may be provided with a “Go to inquiry form” button (not shown) for directing movement to an inquiry form configured to enable inquiries regarding the bid application, and may be configured so as to enable questions to be asked regarding the bid application.

The control unit 21 accepts the input of the bid criteria and applicant information via the bid form (S115), and displays the input bid criteria and applicant information on the bid form. The control unit 21 determines whether or not the OK button in the bid form has been operated (S116), and if the control unit determines that it has not been operated (S116: NO), returns to the step S115 and continues accepting the input of bid criteria and applicant information. If determines that the OK button has been operated (S116: YES), the control unit 21 transmits the input bid criteria and applicant information to the server 10 (S117). The control unit 11 of the server 10 receives the bid criteria and applicant information transmitted from the user terminal 20, and stores the received bid criteria and applicant information in the status DB 12b (S118). Note that, the status DB 12b in this embodiment has a bid information column, and when the control unit 11 receives a bid application for any property, the control unit stores the received bid criteria and applicant information, as well as the date and time at that time (bid application date and time), in the bid information column in correspondence with the property ID. By this type of processing, a user who has been viewing property information can submit a bid for the property they have been viewing, and the control unit 11 of the server 10 can store the bid information related to the received bid application in the status DB 12b, thereby storing the number of bid applications and the bid application history for the property. Note that, when the control unit 11 receives a bid application, the control unit may transmit (transfer) the bid information to the property owner or the person in charge at the real estate company.

Thereafter, the control unit 21 executes the processes from the step S27 onwards. By the above-mentioned process, the server 10 can manage whether or not a bid has been submitted for each property. Therefore, in this embodiment, in the step S24, if the property in the search result is a property for which a bid has been submitted, the control unit 11 of the server 10 generates a property screen displaying information indicating that the property is a property for which a bid has been submitted (for example, “bid property”), as shown in FIG. 21C. Note that, the control unit 11 also displays “bid property” on the property screen shown in FIG. 8 when a bid has been submitted on the property being displayed. This property screen allows the viewer to know whether or not the property in the search result is a property for which a bid has been submitted. In the above-mentioned configuration, the control unit 11 of the server 10 can extract the properties for which bids have been submitted, based on the bid information of each property stored in the status DB 12b. Therefore, the control unit 11 can create and present a list that displays the property information of properties for which bids have been submitted.

Further, in this embodiment, for a property for which a bid has been submitted, contract acceptance is switched to a bidding format for a certain period of time. Specifically, when the property displayed on the property screen is a property for which a bid has been submitted, the “Go to contract form” button on the property screen cannot be operated. Other viewers who wish to make a contract for such a property can submit a bid by operating the “Go to bid form” button. The bidding period during which a contract is accepted in the form of a bid is set according to the contract price desired by the bidder. For example, the higher the contract price desired, the longer the period is set. In this embodiment, for example, in addition to the desired price (rent, sale price, etc.) by the owner of the property, a desired minimum price is acquired in advance and registered in the property information DB 12a. Then, for each property for which a bid has been submitted, when the bidding period set for the bid applicant has elapsed, the control unit 11 of the server 10 may determine that a contract has been concluded if the contract price desired by that bid applicant (a bid applicant for which the bidding period has elapsed) is the highest among the bid applications received up to that point and is also higher than the desired minimum price by the owner of the property. Note that, when the contract price desired by a bid applicant after the bidding period has passed is not the highest price, or is lower than the desired minimum price by the owner of the property, the control unit 11 will determine that the contract has not been concluded and notify the bid applicant of this fact. By this configuration, even if a contract seeker cannot make a contract at the desired price of the owner of the property, the contract seeker can increase the possibility of making a contract for the property the contract seeker likes by submitting a bid for a price that the contract seeker can pay. On the other side, property owners can secure the lowest price they want while minimizing the opportunity loss of closing a property contract.

The configuration of this embodiment is applicable to the information processing systems of the embodiments 1 to 3 described above, and even when applied to the information processing systems of the embodiments 1 to 3, similar processing can be performed and similar effects can be obtained. Further, in this embodiment, the modified examples described in the above-mentioned embodiments 1 to 3 can also be applied as appropriate. Further, in this embodiment, the control unit 11 of the server 10 may be configured so as to accept a bid application after collecting a deposit from a contract seeker.

In the above-mentioned embodiments 1 to 4, the various screens displayed on the user terminal 20 and the shooting terminal 30 may be configured so as to be able to be displayed in a plurality of languages. For example, each screen is provided with a language selection button that allows the user to select any language from a number of languages, and when any language is selected via the language selection button, the control units 21, 31 translate the characters on the displayed screen into the selected language and display the screen written in the selected language on the display units 25, 35. By this configuration, it is possible to prevent the loss of opportunities to register the property information and to enter into the property contracts due to the language used by the shooter who uses the shooting terminal 30 and the user (for example, the viewer) who uses the user terminal 20.

The features described in each embodiment can be combined with each other. Further, the independent and dependent claims set forth in the claims can be combined with each other in any and all combinations, regardless of the form of reference. Furthermore, the claims are in a format in which a claim refers to two or more other claims (multiple claim format), but the present invention is not limited to this format. It is also possible to use a format for describing multiple claims (multi-multi claims) that cite at least one multiple claim.

The embodiments disclosed herein should be considered as illustrative in all respects and not restrictive. The scope of the present invention is defined by the claims, not by the above description, and is intended to include all modifications within the meaning and scope of the claims. Therefore, various design modifications are possible for the present invention, and all such design modifications are included in the present invention.

For example, in the above embodiment, the video content to be shot by the creator may be shot by designating the points that must be shot for each property (for example, the entrance, shoe locker, hallway, toilet, kitchen, dining room, living room, bedroom, study, veranda, and the like). Thereby it is possible to analyze, for example, at what point in the browsing situation the user stopped browsing.

Further, for properties whose video content was produced by creators with low evaluation, or properties for which a deal or sale is slow to be concluded, the price may be lowered, for example, by a predetermined percentage range, so that they are displayed higher level. Thereby, this can increase the turnover rate of property contracts or sales. In order to increase motivation of creators, an award system may be established to award highly evaluated creators.

Further, for example, in the above embodiments 3 and 4, when a creator (shooter) shoots video content of a real estate property, the shooting terminal 30 may be configured to start up a shooting support application 32AP, call up a shooting protocol formed (or classified) based on the size, layout, specifications, and the like of the real estate property, and shoot in accordance with the shooting protocol. In this case, for example, a shooting protocol that specifies a shooting method or procedure for the property is set in the shooting support application 32AP in correspondence with the size, layout, specifications, and the like of the property. Then, when the control unit 31 of the shooting terminal 30 launches the shooting support application 32AP, it may be configured so as to accept input of the size, layout, specifications, and the like of the property to be shot, for example via an input screen, and output shooting advice regarding the shooting method or procedure, or the like, in accordance with the shooting protocol corresponding to the accepted information. By following the provided shooting advice, the creator can take pictures by using a shooting method or procedure that conforms to a shooting protocol that is set according to the size, layout, specifications, and the like of the property.

In addition, at the risk of repeating, it would also be acceptable for the system to have fees for purchases and sales and rentals constantly fluctuating. The sooner a contract is concluded after the listing is started, the lower the seller's fees and lessor's fees may be.

Furthermore, a bidding (or auction) system may be adopted. When accepting applications for one property, a configuration may be adopted in which multiple applications can be accepted at the same time, in which case the bid price can be raised as if in an auction or bidding. Sellers and lessors may be configured so as to negotiate with a plural of buyers and lessees, respectively.

As described above, according to the present invention, it is possible to improve the quality of the introduction and matching of real estate properties through video content, thereby increasing customer satisfaction of users, including contract applicants and owners, and also to make effective use of creators who provide video content. Therefore, the present invention will lead to the revitalization of at least both the real estate industry and the creator industry. The operator of this information processing system is not limited to a real estate company, so individual real estate (rental/transfer) transactions can also be conducted between contract seekers and owners without going through a real estate company.

### EXPRANATION FO SYMBOLS

10 Server
11 Control unit
12 Storage unit
13 Communication unit
20 User terminal
21 Control unit
22 Storage unit
23 Communication unit
12S Property search site

1-8. (canceled)

9. A program in which a computer executes a process of:
sequentially acquiring video content shot of a real estate property shooted by a shooter with a shooting unit, the video content being a moving image which introduces the real estate property detecting the presence or absence of a predetermined object in the acquired video content while the shooting by the shooting unit,
creating a database comprising the real estate property to display a property information of properties, and
making a viewer (contract seeker) view the video content by searching the database,
when the predetermined object is detected, outputting a shooting advice corresponding to the object.

10. The program according to claim 9, in which the computer executes a process of:
detecting the shooting state of the shooter, and
outputting a shooting advice corresponding to the detected shooting state.

11. The program according to claim 9, in which the computer executes a process of:
adding an index related to the object to be shot to frames of the video content.

12. The program according to claim 9, in which the computer executes a process of:
calculating a price of the real estate property or the fee from the owner of the real estate property based on the period until a contract for renting or purchasing the real estate property is concluded by the viewer.

13. The program according to claim 9, in which the computer executes a process of:
displaying the real estate property lower in the property information as the period until the contract for renting or purchasing the real estate property is concluded by the viewer becomes longer.

14. The program according to claim 9, in which the computer executes a process of:
calculating the evaluation score for the shooter based on the period until the contract for renting or purchasing the real estate property is concluded by the viewer.

15. The program according to claim 9, in which the computer executes a process of:
accepting, when a contract price desired by a contract seeker for the real estate property is accepted, a contract application for the real estate property in the form of a bidding for a certain period of time.

16. A program in which a computer executes a process of:
sequentially acquiring video content shot of a real estate property shooted by a shooter with a shooting unit, the video content being a moving image which introduces the real estate property
detecting the presence or absence of a predetermined object in the acquired video content while the shooting by the shooting unit,
creating a database comprising the real estate property to display a property information of properties, and
making a viewer (contract seeker) view the video content by searching the database,
when the predetermined object is detected, outputting a shooting advice corresponding to the object.

17. An information processing method in which a computer executes a process of:
sequentially acquiring video content shot of a real estate property shooted by a shooter with a shooting unit, the video content being a moving image which introduces the real estate property
detecting the presence or absence of a predetermined object in the acquired video content while the shooting by the shooting unit,
creating a database comprising the real estate property to display a property information of properties, and
making a viewer (contract seeker) view the video content by searching the database,
when the predetermined object is detected, outputting a shooting advice corresponding to the object.
